(19) United States
(12) Patent Application Publication
(10) Pub. No.: US 2025/0052872 A1
(43) Pub. Date: Feb. 13, 2025

(54) A SYSTEM AND METHOD FOR LIDAR BLOCKAGE DETECTION

(71) Applicant: Innoviz Technologies Ltd., Rosh Ha'ayin (IL)

(72) Inventors: Yuval Yifat, Tel Aviv-Yafo (IL); Idan Bakish, Hod Hasharon (IL); Dvir MUNK, Givat-Shmuel (IL); Ronen Eshel, Herzliya (IL); Yuval STERN, Even Yehuda (IL); Oren Navon, Ganei Tikva (IL)

(73) Assignee: Innoviz Technologies Ltd., Rosh Ha'ayin (IL)

(21) Appl. No.: 18/718,432

(22) PCT Filed: Dec. 8, 2022
(86) PCT No.: PCT/IB2022/061938

§ 371 Date: Jun. 10, 2024

Related U.S. Application Data
(60) Provisional application No. 63/287,099, filed on Dec. 8, 2021.

(51) Int. Cl. G01S 7/497; G01S 7/481; G01S 7/4865; G01S 17/894

(52) U.S. Cl. CPC G01S 7/497; G01S 7/4813; G01S 7/4815; G01S 7/4816; G01S 7/4817; G01S 7/4865; G01S 17/894; G01S 2007/4975

(57) ABSTRACT

There is provided a LIDAR system and method for surveying a Field of View (FOV) comprising: an illumination system, a light-sensitive detector, a scanning unit and at least one processing unit, wherein the illumination system is configured to project a first light with first illumination parameters, deflected by the scanning system through a window toward the field of view of the LIDAR system; and the light-sensitive detector is configured to receive light reflected from objects in the field of view and deflected by the scanning unit; and the at least one processing unit is configured to analyze detected light and determine information about the objects, and wherein the illumination system is further configured to project a second light with second illumination parameters toward a window vicinity.

### FIELD OF THE INVENTION

The present disclosure generally relates to surveying technology for scanning a surrounding environment and, more specifically, systems and methods that use LIDAR technology to detect objects in the surrounding environment.

### BACKGROUND

With the advent of driver assist systems and autonomous vehicles, automobiles need to be equipped with systems capable of reliably sensing and interpreting their surroundings. Such systems are required to identify obstacles, hazards, objects, and other physical parameters that might impact navigation of the vehicle. To this end, several technologies have been suggested including radar, LIDAR (light detection and ranging system), camera-based systems, operating alone or in a redundant manner.

LIDAR (a.k.a LADAR) is an example of technology that can work well in differing conditions, by measuring distances to objects by illuminating objects with light (such as laser) and measuring the reflected pulses with a sensor.

One consideration with driver assistance systems and autonomous vehicles is the ability of the system to determine surroundings across different conditions including, rain, fog, darkness, bright light, and snow. A light detection and ranging system, (LIDAR a.k.a LADAR) is an example of technology that can work well in differing conditions, measuring distances to objects by illuminating objects with light and measuring the reflected pulses with a sensor. A laser is one example of a light source that can be used in a LIDAR system.

As with any sensing system, for a LIDAR-based sensing system to be fully adopted by the automotive industry, the system should provide reliable data enabling detection of far-away objects.

Many LIDAR systems are installed with dedicated monitoring and cleaning systems to prevent the build-up of blockages and/or obstructions on the system window. Blockages and obstructions on the system window impede the LIDAR performance, especially for externally mounted systems that are exposed to the harsh road environment.

The maximum illumination power of LIDAR systems is limited by the need to make the LIDAR systems eye-safe (i.e., so as not to damage the human eye which can occur when a projected light emission enters through the eye's cornea and lens, causing thermal damage to the retina.)

One method of mitigating eye-safety risks is to implement a system with a built-in mechanism to monitor the immediate environment of the system and reduce emissions to an eye-safe level upon detection of reflections from close-range objects in the Field of View (FOV). U.S. Pat. No. 10,281,582 assigned to the assignee of the present application, discloses an exemplary eye-safety mechanism.

In some eye-safety mechanisms, each time the eye-safety mechanism is activated, there is a recovery time before the system returns to full operational capacity, and the overall system performance is degraded. Overall system performance is degraded, especially in the event of a false detection.

False detections of the presence of persons in the immediate environment of the system are commonly confused with detection of window blockages and obstructions present on or near the protective window of the system. The window may be a protective element being part of a housing containing part or all of the LIDAR elements, or an external protective window.

Obstructions on the protective window of the system may block light passage through the protective window. For example, the vehicle may come in contact with e.g., salt, mud, road grime, snow, rain, dust, bug debris, pollen, and bird droppings (among other things) which may block light from passing through the protective window of the system. Blockages of light may be complete or partial. For example, in some cases, the blockage may be substantially opaque or, alternatively, may be translucent or semi-transparent and may allow at least some light to pass. In some cases, the blockage may limit an amount of incident light through refraction of light (e.g., especially away from an intended light reception path or away from relevant sensors) . . . . Additionally, a blockage may occur only over a portion of the protective window relevant to the system or may be more widespread.

There is a need in the art to improve the identification and the detection of the presence of blockage and/or obstructions on windows of surveying systems for scanning a surrounding environment such as LIDAR systems.

For LIDAR system having an eye safety mechanism, it would be advantageous to discriminate between a window blockage and an object in close vicinity of the LIDAR in order to avoid triggering the eye safety mechanism when unnecessary, e.g. in the event of a window blockage when there is no eye safety hazard.

### SUMMARY

There is provided a LIDAR system for surveying a Field of View (FOV) comprising: an illumination system, a light-sensitive detector, a scanning unit and at least one processing unit, wherein the illumination system is configured to project a first light with first illumination parameters, deflected by the scanning system through a window toward the field of view of the LIDAR system; and the light-sensitive detector is configured to receive light reflected from objects in the field of view and deflected by the scanning unit; and the at least one processing unit is configured to analyze detected light and determine information about the objects, and wherein the illumination system is further configured to project a second light with second illumination parameters toward a window vicinity, wherein the first illumination parameters differ from second illumination parameters by at least one illumination parameter; and the light-sensitive detector is configured to receive second light reflections in response to the second light, and the at least one processing unit comprises a window module to analyze second light reflections and determine a presence of a window blockage.

The illumination parameters may comprise light energy, light intensity, peak power, average power, light wavelength, pulsed light form, pulsed light duration, pulsed light timing.

The at least one illumination parameter may comprise light energy, and wherein the light energy of the second light is lower than the light energy of the first light.

The energy of the second light may be 10-200 times lower than the energy of the first light.

Each of the first and second light may have a wavelength between 700 nm-1000 nm.

The illumination unit may be configured to project pulsed light toward the FOV and toward the window in non-overlapping time intervals such that light reflected from the field of view and light received in response to projecting light toward the window arrive to the light-sensitive detector in non-overlapping time intervals.

The LIDAR system may further comprise a readout unit to read light-sensitive detector signals, and the light reflected from the field of view may be received in a first time interval, and the light received in response to window illumination may be received in a second time interval, and; the processing unit may control a readout sampling frequency during a first time interval and a second time interval.

The readout sampling frequency during the second time interval may be higher than the frequency in the first time interval.

The illumination system may comprise a FOV illumination unit with a first light source configured to project light with first illumination parameters, and a window illumination unit with a second light source configured to project light with second illumination parameters.

The first light source may be one of a group consisting of: solid-state laser, laser diode, a high-power laser, vertical-cavity surface-emitting laser (VCSEL), external cavity diode laser (ECDL).

The second light source may be one of a group consisting of: laser source, LED diode, flash light source.

the illumination system may comprise a single pulsed light source and a light modulating unit configured to set one or more illumination parameters from a group consisting of: light energy, light intensity, peak power, average power, light wavelength, light form, light duration, light timing.

The light modulating unit may be configured to set one or more first illumination parameters for the projection of first light towards the FOV and one or more second illumination parameters, different from the one or more first illumination parameters, for projection of second light towards the window.

The illumination system may comprise a single light source with controllable emission energy such that the energy of the second light is lower than the energy of the first light.

At least one of the first light and the second light may be projected as a sequence of light pulses.

Both the first light and second light may be projected as a sequence of light pulses and a pulse duration of the first light may be shorter than the pulse duration of the second light.

The second light reflections may be deflected by the scanning unit towards the light-sensitive detector.

The processing unit 110 may further be configured to generate point cloud data points comprising distance information relative to objects in the field of view based upon signals generated by the at least one light-sensitive detector in response to the first light projected toward the field of view, and blockage information based upon signals generated by the at least one light-sensitive detector in response to the second light projected towards the window.

Blockage information may include at least one of: a blockage indicator, percent blockage, and a blockage transparency.

The illumination system may comprise at least one FOV light source operable with the FOV illumination unit and at least one window light source operable with the window illumination unit.

At least one window light source may be positioned behind the window to illuminate a backside of the window at one or more illumination angles.

The window light source may be positioned to illuminate the window through an edge of the window.

The window light source may comprise multiple light sources.

The multiple light sources of the window light source may be positioned to illuminate the window through more than one edge of the window.

The light-sensitive detector may be a SiPM sensor.

In response to determining the presence of an obstruction on the window, the processing unit may perform one or more actions from a group consisting of: determining information about the obstruction, communicating the obstruction information to an external system, affecting an operating parameter of the FOV illumination unit.

The processing unit may determine information about the obstruction including at least one of a location on the window, a size, a shape, a transparency of the obstruction, based on at least one of an angle of illumination, a position information of the deflector, intensity of signal, form of signal, and a signal detection time information.

There is provided a method for surveying a Field of View (FOV) by a LIDAR system, the method comprising: projecting first light with first illumination parameters, deflected by a scanning system through a window toward the FOV of the LIDAR system; receiving, through a window and by a light-sensitive detector, light reflected from objects in the FOV and deflected by the scanning system; analyzing detected light and determining information about the objects, and projecting second light with second illumination parameters, toward a window vicinity; wherein the first illumination parameters differ from second illumination parameters by at least one illumination parameter; receiving, by the light-sensitive detector, second light reflections in response to the second light; analyzing second light reflections and determining a presence of a window blockage.

The second light may be deflected towards the window by the scanning system.

The second light reflections may be deflected towards the light-sensitive detector by the scanning system.

Each of the first light and second light may have a wavelength between 700 nm-1000 nm.

The projecting second light toward the window may comprise generating one or more light pulses.

The projecting first light and the projecting second light may be done in non-overlapping time intervals such that first light reflections from the field of view and second light reflection received in response to projecting second light toward the window arrive to the light-sensitive detector in non-overlapping time intervals.

At least one of the projecting first light and the projecting second light toward the window may comprise generating a sequence of non-overlapping light pulses.

The illumination parameters may comprise light intensity, light wavelength, peak power, average power, pulsed light form, pulsed light duration, pulsed light timing.

The projecting second light may comprise illuminating the window through an edge of the window.

The projecting second light may comprise illuminating a back side of the window at one or more illumination angles.

The projecting second light may comprise modulating a single light source with controllable emission energy such that the energy of the second light is lower than the energy of the first light.

The method may further comprise, in response to determining the presence of a window blockage, performing one or more actions from a group consisting of: determining information about the obstruction, communicating the obstruction information to an external system, affecting an operating parameter of the FOV illumination unit.

The determining information about the obstruction may comprise determining at least one of a location on the window, a size, a shape, a transparency of the obstruction, based on at least one of an angle of illumination, a position information of the deflector, and a signal detection time information.

There is provided a LIDAR system for surveying a Field of View (FOV), comprising: an illumination system, a light-sensitive detector, a scanning unit and at least one processing unit configured to: control the illumination unit to project first light with first illumination parameters and second light with second illumination parameters, wherein the first illumination parameters differ from second illumination parameters by at least one illumination parameter; control the scanning unit to deflect the first light through a window toward the FOV and optionally deflect the second light toward the window, and deflect light reflected from the FOV and the window toward the light-sensitive detector; analyze light detected by a light-sensitive detector in response to receiving light reflected from objects in the field of view and light generated in response to second light, and determine a presence of an obstruction on the window.

The illumination parameters may comprise light intensity, light energy, light wavelength, pulsed light duration, pulsed light timing.

There may be provided a method for surveying a Field of View (FOV), comprising: controlling an illumination unit of a LIDAR system to project first light with first illumination parameters and second light with second illumination parameters, wherein the first illumination parameters differ from second illumination parameters by at least one illumination parameter; controlling a scanning unit of the LIDAR system to deflect the first light towards the field of view (FOV) of a window toward a Field of View (FOV) of the LIDAR system and optionally deflect the second light toward the window, and deflect first light reflections reflected from the FOV and the window toward a light-sensitive detector; analyzing light detected by a light-sensitive detector in response to receiving second light reflections in response to second light, and determining a presence of an obstruction.

The illumination parameters may comprise light intensity, light energy, light wavelength, pulsed light duration, pulsed light timing.

There may be provided a non-transitory computer-readable medium storing instructions that, when executed by one or more processors, cause the one or more processors to: controlling an illumination unit of a LIDAR system to project first light with first illumination parameters and second light with second illumination parameters, the one or more second illumination parameters, wherein the first illumination parameters differ from second illumination parameters by at least one illumination parameter; controlling a scanning unit of the LIDAR system to deflect the first light towards the field of view (FOV) of a window toward a Field of View (FOV) of the LIDAR system and optionally deflect the second light toward the window, and deflect first light reflections reflected from the FOV and the window toward a light-sensitive detector; analyzing light detected by a light-sensitive detector in response to receiving second light reflections in response to second light, and determining a presence of an obstruction.

The illumination parameters may comprise light intensity, light energy, light wavelength, pulsed light duration, pulsed light timing.

There may be provided a LIDAR system for surveying a Field of View (FOV) comprising: an illumination system, a light-sensitive detector, a scanning unit and at least one processing unit, the illumination system comprising a FOV illumination unit to project light at a first energy through a window toward the field of view of the LIDAR system; and the light-sensitive detector is to receive light reflected from objects in the field of view and deflected by the scanning unit; and the at least one processing unit is configured to analyze detected light and determine information about the objects, wherein the illumination system further comprises a window illumination unit to project light at a second energy, lower than the first energy, toward a window; and the light-sensitive detector is configured to receive second light reflections in response to light projected at the second energy toward the window and the at least one processing unit is configured to analyze detected light and determine a presence of an obstruction on the window.

The second light may be further deflected by the scanning system toward the FOV.

There may be provided A LIDAR system for surveying a Field of View (FOV) comprising: an illumination system, a light-sensitive detector, a scanning unit and at least one processing unit, the illumination system may be configured to project light at a first energy through a window towards the FOV of the LIDAR system, and to project light at a second energy, lower than the first energy, toward a window; the light-sensitive detector may be configured to receive light reflected from objects in a portion of the FOV, and light reflected from a portion of the window in response to light projected at the second energy toward the window; and the at least one processing unit is configured to analyze detected light in response to the second energy illumination and determine a presence of an obstruction on the window, and analyze detected light in response to the first energy illumination and determine information about detected objects

The LIDAR system may further comprise a scanning unit configured to deflect reflected light towards to light-sensitive detector.

The scanning unit may deflects light projected at the first intensity towards the FOV.

The processing unit may further generate a point cloud data point comprising the position of the object, and blockage information.

Blockage information may include at least one of: a blockage indicator, percent blockage, and a blockage transparency.

There may be provided a LIDAR system for surveying a Field of View (FOV) comprising: an illumination system, a light-sensitive detector, a scanning unit and at least one processing unit, the illumination system may comprise a FOV illumination unit to project a first pulse of light at a first energy, deflected by the scanning system through a window toward the field of view of the LIDAR system; and the light-sensitive detector is configured to receive light reflected from objects in the field of view and deflected by the scanning unit; and the at least one processing unit is configured to analyze detected light and determine information about the objects, wherein the illumination system may further comprise a window illumination unit to project a second pulse of light at a second energy, lower than the first energy, toward a window; and the light-sensitive detector is configured to receive light generated in response to the pulse of light projected at the second energy toward the window and the at least one processing unit may comprise a window module to analyze detected light and determine a presence of an obstruction on the window.

The second energy may be between 10-200 times lower than the first energy.

The peak power of the second light pulse may be lower than the peak power of the first light pulse.

The duration of the second light pulse may be shorter than the duration of the first light pulse.

There is provided a LIDAR system for surveying a field of view (FOV), the LIDAR system comprising: a FOV illumination unit that is configured to illuminate at least a part of the FOV with first light, the first light passes through a window; a window obstruction illumination unit that is configured to illuminate at least a part of a window field of vision with second light; wherein the window field of vision comprises at least a part of the window; wherein the window field of vision has a shorter range than the FOV; wherein the first light differs from the second light by at least one illumination parameter; and a detection unit that is configured to (i) detect first reflected light that is reflected from one or more objects within the at least part of the FOV, as a result of the illumination of the at least part of the FOV with the first light; and (ii) detect second reflected light from the at least part of the window field of vision, as a result of the illuminating the at least a part of the window field of vision with second light.

The second reflected light may be deflected by a scanning unit towards the detection unit.

The FOV illumination unit may comprise a FOV light source and wherein the window obstruction illumination unit comprises a window light source.

The FOV illumination unit and the window obstruction illumination unit may share an illumination source.

The at least one first processing unit is further configured to generate depth information regarding the objects based on detection signals generated by the detection unit in response to the first reflected light.

The LIDAR system may further comprise at least one first processing unit that is configured to determine FOV object information about the one or more objects.

The LIDAR system may further comprise at least one second processing unit that is configured to determine window field of vision obstruction information.

The at least one second processing unit may be configured to generate window obstruction information based on detection signals generated by the detection unit in response to the second reflected light.
the second processing unit may be configured to generate window obstruction information also in view of at least one of an angle of illumination of the second light, a position information of a deflector that deflected the second reflected light towards the sensing unit, an intensity of the second light, and a second light detection time information.

There may be provided a method for surveying a first Field of View (FOV) by a LIDAR system, the method comprising: first illuminating, by a FOV illumination unit, at least a part of the FOV with first light, the first light passes through a window; second illuminating, by a window obstruction illumination unit, at least a part of a window field of vision with second light; wherein the window field of vision comprises at least a part of the window; wherein the window field of vision has a shorter range than the FOV; wherein the first light differs from the second light by at least one illumination parameter; and first detecting, by a detection unit, first reflected light that is reflected from one or more objects within the at least part of the FOV, as a result of the illumination of the at least part of the FOV with the first light; and second detecting, by the detection unit, second reflected light from the at least part of the window field of vision, as a result of the illuminating the at least a part of the window field of vision with second light.

### BRIEF DESCRIPTION OF THE DRAWINGS

For a better understanding of the invention with regard to the embodiments thereof, reference is made to the accompanying drawings, in which like numerals designate corresponding entities throughout, and in which:

FIG. 1 is a block diagram illustrating an exemplary LIDAR system consistent with disclosed embodiments;

FIG. 2a is a schematic diagram illustrating an optical configuration of a LIDAR system in accordance with some of the embodiments of the present disclosure;

FIGS. 2b(a) and 2b(b) schematically illustrate an aspect of the LIDAR system shown in FIG. 2a;

FIG. 3 is a schematic diagram illustrating optical configurations of a LIDAR system in accordance with some of the embodiments of the present disclosure;

FIG. 4a is a schematic diagram illustrating an optical configuration of a LIDAR system in accordance with some of the embodiments of the present disclosure;

FIGS. 4b(a) and 4b(b) schematically illustrate an aspect of the LIDAR system shown in FIG. 4a;

FIG. 5 is a diagram illustrating a window illuminated by multiple light sources.

FIGS. 6A, 6B, 6C and 6D are graphs illustrating examples of timing diagram consistent with some embodiments of the present disclosure.

FIG. 7 is a flowchart illustrating a method for detecting and classifying obstructions according to an embodiment of the invention;

FIG. 8 is a flowchart illustrating a method for detecting obstructions according to an embodiment of the invention;

FIG. 9 is a flowchart illustrating a method performed by a processor for detecting obstructions according to some embodiments of the invention;

FIG. 10 illustrates an example of a LIDAR system;

FIG. 11 illustrates an example of a LIDAR system;

FIG. 12 illustrates an example of a LIDAR system; and

FIG. 13 illustrates an example of a method.

### DETAILED DESCRIPTION OF EMBODIMENTS

In the following description the terms “first” and “second” will be used for distinguishing between method steps and/or light signals and the like. These terms do not represent any order and/or priority and/or significance. The terms “first light” and “second light” may refer to one or more first light signals and one or more second light signals, respectively.

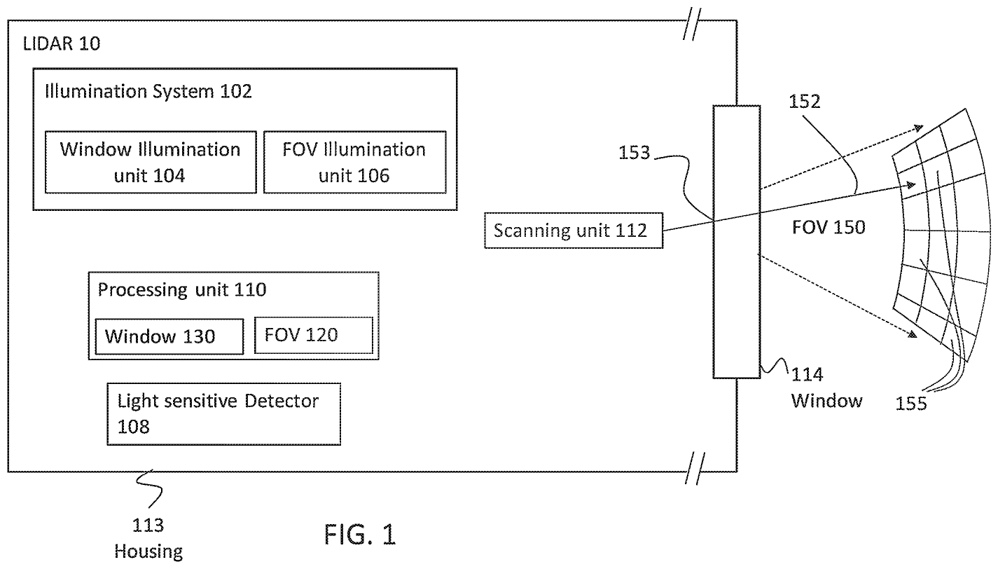

FIG. 1 is a block diagram illustrating an exemplary LIDAR system 10 with an integrated blockage detection mechanism consistent with disclosed embodiments. LIDAR systems are used to survey a scene for objects. Consistent with the present disclosure, LIDAR system 10 may be used in autonomous or semi-autonomous road-vehicles (for example, cars, buses, vans, trucks and any other terrestrial vehicle) (not shown in FIG. 1). Autonomous road-vehicles equipped with LIDAR system 10 may scan their environment and drive to a destination without human input.

An integrated blockage detection mechanism, in contrast with an external blockage detection mechanism, shares hardware or software components with the LIDAR system 10. For example, the integrated blockage detection mechanism is controlled by a processing unit in LIDAR system 10. Detected signal processing of objects and window blockage may be integrated. In another example, the integrated blockage detection mechanism uses one or more hardware components housed in the LIDAR system, e.g., light source, scanning unit, and/or detection unit. In yet another example, a dedicated blockage detection light source is placed within the LIDAR housing to provide e.g., window edge illumination and/or window backside illumination. In some embodiments, the integrated blockage detection mechanism and its operation are integrated with an eye-safety mechanism and its operation.

Consistent with disclosed embodiments, a blockage (also referred to as an obstruction) may describe an unwanted object on the protective window of a LIDAR system, or near the protective window of a LIDAR system. Blockages may be close-range object, such as objects within 5 meters of the LIDAR system, or objects within 10 m of the LIDAR system.

LIDAR system 10 comprises an illumination system 102, a light-sensitive detector 108, a scanning unit 112 and a processing unit 110. Further shown is a housing 113 with a protective optical window 114 through which light is projected towards a field of view (FOV) 150. LIDAR System 10 may be mounted on a vehicle in a dedicated chamber, having an external protective window (not shown).

Consistent with embodiments of the present disclosure, Illumination System 102 (illuminator 102) may include at least one light source, scanning unit 112 may include at least one light deflector, light-sensitive Detector 108 may include at least one sensor, and processing unit 110 may include at least one processor. The terms ‘illumination system’ and ‘illuminator’ may be used herein interchangeably.

Consistent with embodiments of the present disclosure, illumination system 102 may include a Field of View (FOV) illumination unit 106 and a Window Illumination unit 104.

The FOV illumination unit 106 is configured to project first light with first illumination parameter towards targets (objects) in the LIDAR Field of View (FOV) of the LIDAR system 10.

In some embodiments, the FOV illumination unit 106 is configured to project first light at a first intensity towards targets (objects) in the LIDAR Field of View (FOV) of the LIDAR system 10.

The first illumination may be referred to as ‘ranging illumination’ or ‘object illumination’ or ‘first light’. Ranging refers to determining the distance of an object in the FOV of the LIDAR system 10 from the LIDAR system 10. Ranging illumination may be illumination projected for detecting objects in the FOV of the LIDAR system 10. The intensity of ranging illumination may be adapted according to the maximal range of the LIDAR System 10.

The window illumination unit 104 is configured to project second light with second illumination parameters (window illumination) towards a window vicinity for detection of window blockages.

The vicinity of the window refers to a region on or near the window, up to 3 meters from the window. The FOV of the LIDAR system may be illuminated with ranging illumination to detect objects up to 200, 250 or 300 meters from the LIDAR system.

Illumination parameters may be light energy, light intensity, light wavelength, pulsed light form, pulse peak power, pulse average power, pulsed light duration (pulse width), pulsed light timing.

In some embodiments, the second illumination parameters differ from the first illumination parameters by at least one parameter. In some embodiments, the second light energy is lower than that of the first light. For example, a second light pulse may have a lower intensity or peak power than a first light pulse. Alternatively, a second light pulse may have a shorter duration than a first light pulse.

In some embodiments, the window illumination unit 104 is configured to project illumination at a second intensity, lower than the first intensity, towards a protective window (also referred to as ‘window’) 114 for detection of obstructions on window 114.

The second intensity emissions, generated by the window illumination unit 104, may be referred to as ‘blockage detection illumination’. Since blockages on the window 114 are located at a short distance, e.g. between 0 and 3 meters from from the LIDAR system 10, blockage detection illumination may be emitted at a low intensity, relative to ranging illumination.

light energy is a function of power and illumination time. In some embodiments, the intensity or peak power of the projected light may be adapted. In some embodiments, light pulse width may be adapted.

Thus, illumination system 102 may be equally described as comprising a Field of View (FOV) illumination unit 106 and a Window Illumination unit 104, where the FOV illumination unit 106 is configured to project a first pulse of light at a first energy level towards targets (objects) in the FOV of the LIDAR system 10. The Window illumination unit 104 is configured to project a second pulse of light at a second energy level, lower than the first energy level, towards window 114. The energy of the pulse, which is a function of both the pulse power and duration, may be adapted according to the maximal range of the LIDAR System 10.

Since blockages on the window 114 are located at a short distance from the LIDAR system 10 comparing objects in the FOV, blockage detection pulses may be emitted at a low energy, relative to ranging pulses.

Lower energy blockage detection pulses increase the dynamic range of the LIDAR system. When a low energy pulse is emitted, the parasitic pulse (also referred to as internal reflections from the system) on the detector is decreased correspondingly, and the detector recovery is faster. Fast detector recovery enables better separation between the parasitic signals and reflections from blockages, enabling detection of blockages on the system window and/or near the system window.

The first and second intensities may be realized by controlling the energy level of the emitted pules, the pulse width and pulse power.

Illumination system 102 may be realized in several ways. According to embodiments of the invention, the illumination System 102 may comprise at least one light source. In single light source embodiments, the single light source (not shown in FIG. 1) may operate in two operational modes to generate both FOV illumination and Window illumination, each at a different intensity. According to other embodiments of the invention, illumination system 102 may include two or more light sources, each capable of generating light at a defined intensity (defined energy level, defined pulse width or defined pulse power).

In some embodiments, the single light source may be modulated by a modulating unit, e.g. a laser driver, configured to trigger the laser to emit laser pulses with different energy levels. The laser driver may be configured to trigger emission of laser pulses with different widths, different heights (peak power), or a combination of different widths and heights.

In some embodiments employing two light sources, the FOV illumination unit 106 light source may be a laser light source to illuminate the Field of View (FOV) of the LIDAR, and the window illumination unit 104 light source may be a Light emitting diode (LED).

In some embodiments employing a single light source, a pulsed laser source may be used with a laser driver. The pulsed laser light source may be modulated to emit a high intensity (high energy level) pulse for ranging, followed by a low intensity (low energy level) pulse for blockage detection. The laser may be modulated to emit a wide pulse for ranging, followed by a narrow pulse for blockage detection. The low energy pulse may have an energy between 10-200 times lower than the ranging pulse.

The laser may be modulated to emit a pulse with a high peak power for ranging, followed by a pulse with a lower peak power for blockage detection. The low energy pulse may have an energy between 10-200 times lower than the ranging pulse.

Consistent with disclosed embodiments, the LIDAR system 10 may include at least one light source configured to project light. As used herein the term “light source” broadly refers to any device configured to emit light. In one embodiment, the light source may be a laser such as a solid-state laser, laser diode, a high-power laser, or an alternative light source such as, a light emitting diode (LED)-based light source. In addition, Illumination System 102 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value.

Light pulses used to illuminate the FOV may have parameters (also referred to as illumination parameters) such as: pulse duration, pulse angular dispersion, wavelength, instantaneous power, photon density at different distances from light source, average power, pulse power intensity, peak power, pulse width, pulse repetition rate, pulse sequence, pulse duty cycle, wavelength, phase, polarization, pulse energy, and more.

FOV illumination unit emits high intensity illumination (for example high power laser pulses) required to illuminate objects in the FOV of LIDAR system 10 that are located at long distances from the LIDAR system. For example, long range may refer to distances between 10 and 500 meters from the LIDAR system 10. In contrast, relatively low intensity illumination is required to detect obstructions on window 114, which is typically located within 5-30 cm from the Light source, or up to 3 m from the LIDAR system window. In some embodiments, the FOV illumination unit 106 may include at least one light source.

For example, the peak power of the FOV illumination may be in the range of 10-500 watts (W), 10-100 W, or 100-500 W.

For example, the pulse width of a pulse of light emitter by the FOV illumination unit may be in the range of 2-10 ns, or 4-7 ns. The pulse width may be about 5 ns.

The FOV illumination may be concentrated in a portion of the FOV. For example, the portion of the field of view may be 0.1-1 degrees².

The intensity of the window illumination may be in the range of 0.1-1 W.

The pulse width of a pulsed window illumination may be in a range of 500 ps-1 ns, or 1-2 ns.

The window illumination may illuminate a larger area than the FOV illumination. For example, window illumination may illuminate the entire window.

The window illumination intensity may be greater than that of Sunlight in order to obtain a Signal to Noise ratio (SNR) to enable confidence in detections. For example, the ambient light impinging on the window illumination intensity may be at least 0.1-1 Kilowatt per square meter (kW/m²). The window illumination may in the range of 5-20 Kilowatts per square meter (kW/m²).

The window illumination may emit bursts of light with power in the range of 100 mW and 1 W. The window illumination may emit 100 mW bursts of light. The term burst of light and pulse of light may be used interchangeably.

The window illumination unit 104 may have a fast switching time. For example, the window illumination unit 104 light source may have a rise and fall time of approximately 10 ns.

A scanning unit (scanning system) 112 deflects the projected light through the protective window 114 towards various portions 155 of the FOV 150. Received light is deflected by the scanning unit 112 towards the light-sensitive detector 108. Received light includes both light reflected from objects in the FOV resulting from illuminating the FOV with ranging illumination, and light generated in response to blockage detection illumination projected at a lower intensity towards the protective window 114. For example, in the presence of an obstruction on or near the window 114 (window vicinity), light scattered by an obstruction on or near the window 114 will be deflected by the scanning unit 112 and received by the detector 108. The light-sensitive detector 108 is configured to sense incoming light including light coming from blockages on the window 114 and reflections from objects in the FOV of the LIDAR system 10.

Scanning unit 112 light deflector may be realized in any technique known in the art, for example, a mirror, a prism, a controllable lens, a mechanical mirror, mechanical scanning polygons, active diffraction (e.g. controllable liquid Crystal), MEMS (Micro-Electro-Mechanical Systems) mirror, or optical phased arrays. The light deflector may be configured to pivot about at least one axis in order to scan the FOV. The light deflector may be configured to pivot about more than one axis to perform a 2D scan of a FOV. In some embodiments, the scanning unit 112 may comprise a set of light deflectors scanning synchronously or asynchronously. The term light deflector and scanner may be used interchangeably. In some embodiments, the LIDAR system may scan a 360 degree Horizontal FOV by rotation.

During a scanning cycle, each instantaneous position of the light deflector may be associated with a particular angle of illumination or ‘pointing direction’ (e.g., 152) associated with a particular portion of the FOV 155. As such, each instantaneous position of the light deflector is associated with a particular position 153 on the window 114 through which the FOV illumination is projected. Associating the time of light transmission with the instantaneous position of the light deflector enables the association of signals received by the detector 108 with their spatial position, and thus enables localization of objects detected.

It is to be understood that FOV object ranging and analysis operations do not form part of the present disclosure and therefore are not described herein in details, except to note the following: The processing unit 110 may be configured to analyze by its FOV module 120, the reflections from objects in the FOV detected by the light-sensitive detector 108 to determine information (for example ranging information, depth information and other information) about the objects. The processing unit 110 may further be configured to generate a point cloud including distance information relative to objects in the field of view of the LIDAR system based on output signals generated by the at least one light-sensitive detector in response to received light return signals emitted by the FOV illumination unit and reflected from the objects in the field of view. Processing unit 110 may further be configured to provide, on a pixel-by-pixel basis for each point in the point cloud, a parameter indicating whether a blockage on the window 114 was detected during the reading (‘blockage indicator’). For example, each point in the point cloud may include data such as position with respect to a reference position (X, Y, Z), target reflectivity, blockage indicator (blocked/unblocked), percent blocked area of a pixel, percent transparency of blockage, etc.

Disclosed embodiments enable the correlation of blockage parameters with data points in the point cloud. The scanning unit 112 deflects all light reflected to the LIDAR system towards a common detector.

Processing unit 110 may be further configured to analyze, by its window module 130, light generated in response to blockage detection illumination projected towards the window 114, that was detected by the light-sensitive detector 108 to determine the presence of an obstruction in the vicinity of the window 114. Processing unit 110 may be further configured to analyze, by its window module 130, to determine additional information about the obstruction on the window 114.

Processing unit 110 (or another processor, not shown in FIG. 1) may be configured to coordinate the operation of illumination system 102 with the operation of scanning unit 112 in order to scan the field of view.

In some embodiments, the window 114 is included as a component of system 10, for example in the housing of the system 10. Additionally, or alternatively, the window 114 may be associated with a platform upon which system 10 is associated (e.g., a vehicle). In still other embodiments, the protective window 114 may include light transmissive components from both LIDAR system 10 and the platform upon which LIDAR system 10 is deployed. In some embodiments, the window 114 may be the optical window of the LIDAR system 10. In some embodiments, e.g., in which the system 10 is mounted in the interior of a vehicle, the window 114 may be or include the windshield or a window of the vehicle. In some embodiments, the window 114 or any of its components may be formed of glass, plastic, or any other suitable material. The window 114 may be flat, curved, or of any other shape. The window 114 may serve an optical purpose in addition to being protective. For example, the window may collimate light, filter certain wavelengths, etc.

In some embodiments, the optical window 114 may be an opening, a flat window, a lens, or any other type of optical window. In some embodiments, System 10 may include a window 114 disposed between at least one component of the LIDAR system 10 (e.g., the light-sensitive detector 108) and a scene to be imaged. The window 114 may be composed of any light transmissive medium through which light (e.g., light projected by Illumination System 102 to a scene to be imaged, reflected light received from the scene, ambient light, light from an internal light source, etc.) may at least be partially transmitted.

Protective window 114 and the external window, if exists, may have high transmission properties for the wavelength of the illumination system 102 emissions, including both ranging illumination and blockage detection illumination. For example, if the FOV illumination unit 106 light source emits light at about 905 nm, the window is desirably transparent to 905 nm light in order to effectively emit light to the environment and receive reflected light from the environment without significant losses.

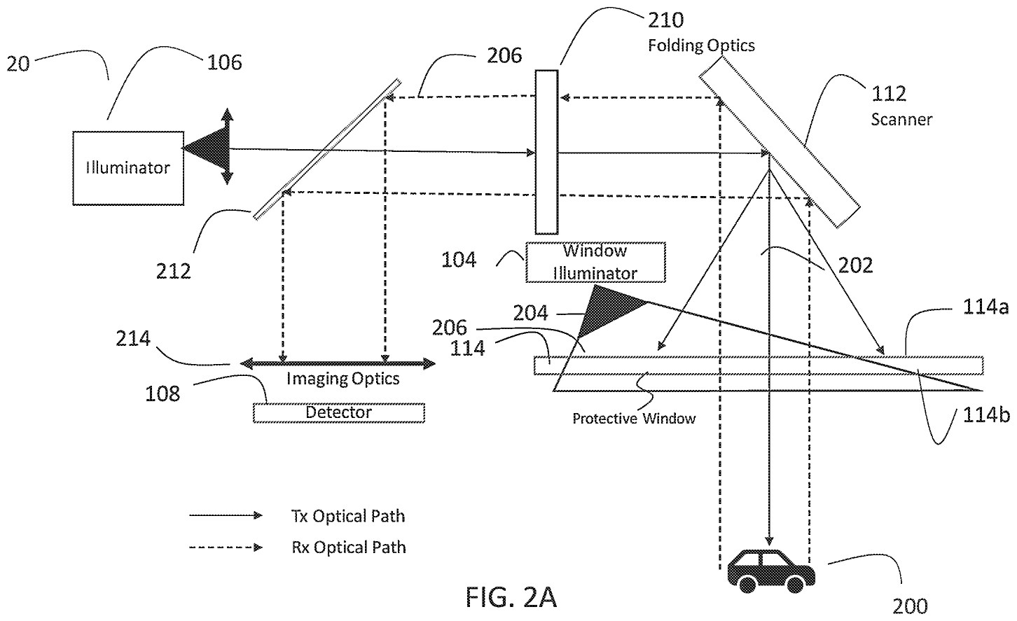

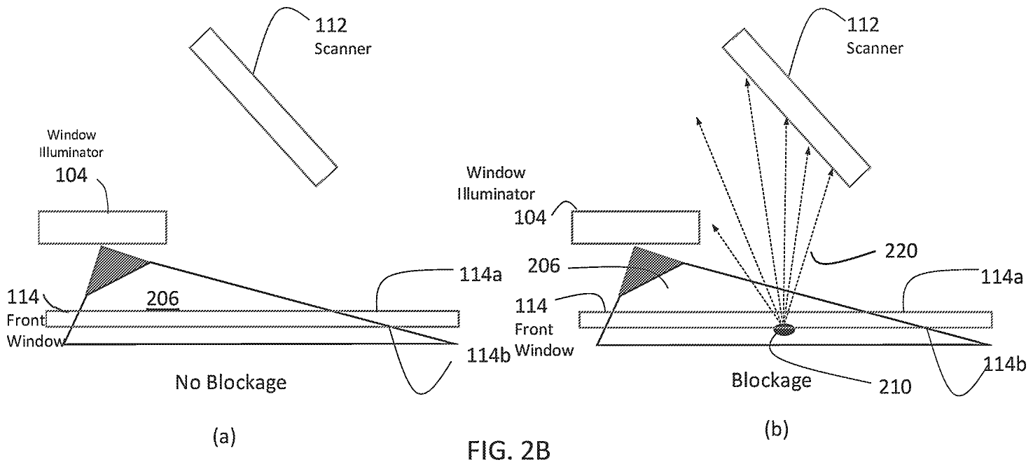

FIG. 2a schematically illustrates an example optical configuration of LIDAR system 10 of FIG. 1 with an illumination system 102 employing two light sources. System 20 may include a FOV illuminator 106 to emit light projected towards the scanner 112 via folding optics 210. Scanner 112 deflects the light through the front window 114, towards the FOV to scan the FOV along the transmitted optical path 202 (Tx), denoted by a solid line. One object in the FOV-car 200, is shown. In this example, a Window illuminator 104 is configured to illuminate the back side 114a of the front window 114 with illumination 206 of a wavelength detectable by the detector 108. The Window illuminator 104 in this example may comprise at least one LED illuminating light, for example, with a wavelength between 820 nm and 950 nm. The LED illuminating light may emit light at 10 KW/m². The LED illuminating light may emit 1-Watt bursts of light. The Window illuminator 104 may emit light at a wide angle, illuminating a large portion of the window 114, in contrast with the FOV illuminator, which emits concentrated light to smaller portions of the FOV.

For example, the window illuminator 104 may illuminate a portion of the window with dimensions 150 mm×50 mm, corresponding to solid angles of 5-25 degrees². The FOV illuminator may emit light with a solid angle of 0.1-1 degrees².

The FOV illuminator (illumination unit 106 or the illumination unit in its FOV illumination mode of operation) may emit light with a solid angle that differs in the near-field and the far-field. The illuminated portion may be larger in the near-field, and smaller in the far-field due to the configuration and properties of the optical system. The near-field may be up to 20 meters from the LIDAR system, and the far-field may be between 20 and 300 meters from the LIDAR system.

In the non-limiting example illustrated in FIG. 2a, the optical requirements of the window illuminator (illumination unit 104 or the illumination unit 102 in its window illumination mode of operation) may be reduced since the system window 114 is positioned at a short distance from the window illuminator. In contrast, objects in the FOV of the LIDAR system 20, such as car 200, may be located between 20 cm and 500 m from the LIDAR system 20. For close range targets, the light emissions may be lower intensity/energy emissions. Thus, the emissions 204 of the window illuminator may be of a lower intensity or lower energy than emissions 206 of the FOV illuminator, which is configured to illuminate objects in the FOV.

In the collection (Rx) optical path: light reflected from objects in the field of view (car 200) returns to the LIDAR system 20 along the receive optical path 206 (Rx), denoted by a dotted line. The returned light is deflected by scanner 112 and is directed to detector 108 through folding optics 210, mirror 212 and imaging optics 214.

Light received from the window 114 in response to illuminating the window 114 with window illumination, returns on the same receive path (Rx) and is received by detector 108.

FIGS. 2b(a) and 2b(b) schematically illustrate an aspect of the LIDAR system shown in FIG. 2a. FIG. 2b(a) illustrates the example without any blockage present on the window 114. FIG. 2b(b) shows a blockage 210 present on the protective, front window 114. The window illuminator 104 illuminates the backside 114a of front window 114 with illumination 206 such that when no blockage 210 is present on the window 114, as illustrated in FIG. 2b(a), the illumination 206 is transmitted through the window. When a blockage 210 is present on the window 114, light is scattered and reflected off the blockage in various directions. The reflected light from the blockage 220 that is captured by the LIDAR system is then deflected by the scanner 112 towards the detector 108 (not shown in FIG. 2b(b)).

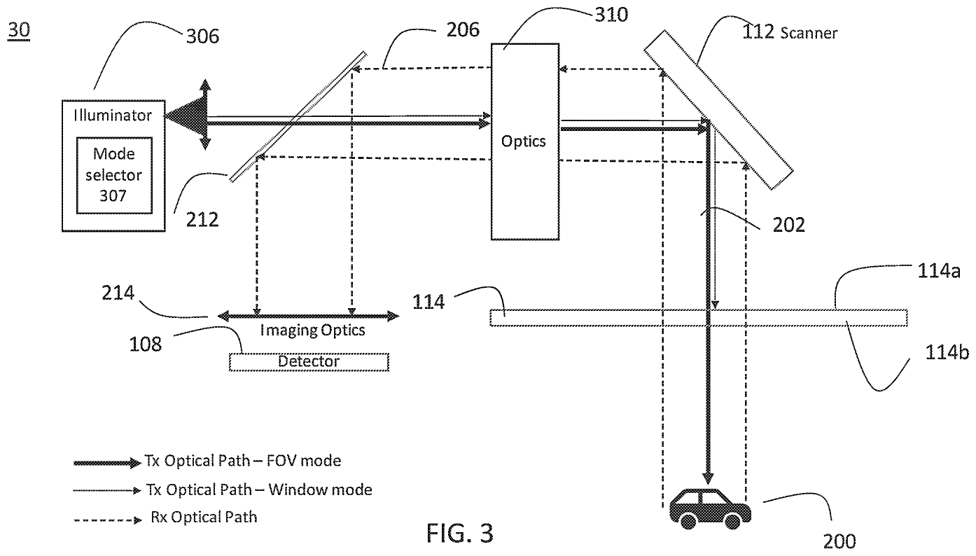

FIG. 3 is a schematic diagram illustrating optical configurations of a LIDAR system 30 in accordance with some of the embodiments of the present disclosure, employing a single light source with mode selector (e.g., a modulation unit) 307. Illuminator 306 is capable of operating in two optical modes: FOV mode, having one intensity, and a window mode, having a second intensity, lower than the first intensity. Alternatively, FOV mode may have one energy, and a window mode may have a second energy, lower than the first energy.

For example, the single light source may be a laser light source configured to emit a first pulse of light at a first intensity, and subsequently emit a second pulse of light at a second intensity, wherein the intensity of the second pulse is lower than that of the first pulse.

In another example, the single light source may be a laser light source configured to emit a first pulse of light at a first pulse width (duration), and subsequently emit a second pulse of light at a second pulse width, wherein the pulse width of the second pulse is shorter than that of the first pulse.

In yet another example, the single light source may be a laser light source configured to emit a first pulse of light at a first energy, and subsequently emit a second pulse of light at a second energy, wherein the energy of the second pulse is shorter than that of the first pulse.

It should be noted that the high intensity pulse may be emitted before or after the low intensity pulse. The first pulse may be configured for detecting objects in the FOV of the LIDAR system 30 (or LIDAR system 10 of FIG. 1), and the second pulse configured for detecting blockages on the system window 114. The second pulse may be emitted each time a first pulse is emitted, or after a number of pulses is emitted, depending on the desired resolution of blockage identification. Illumination system 306 shown in FIG. 3 may comprise a mode selector 307. Mode selector 307 may be for example, a laser driver to control the voltage level of the generated pulse, which in turn may provide a level of control of the illumination parameters, such as laser pulse intensity, width, or energy. The laser driver may control the Illumination System 306 to generate repeated pulses with varying intensities or energies and defined time intervals between pulses.

In the example of FIG. 3, light emitted during the FOV mode and the window modes is projected through the same 212, 310, 112 optical path. This is illustrated with a solid line for the Tx path for the FOV mode and a dotted line for Tx path of the window mode.

The mode selector 307 may be implemented with a processor to determine the mode, and electronics to control the light source.

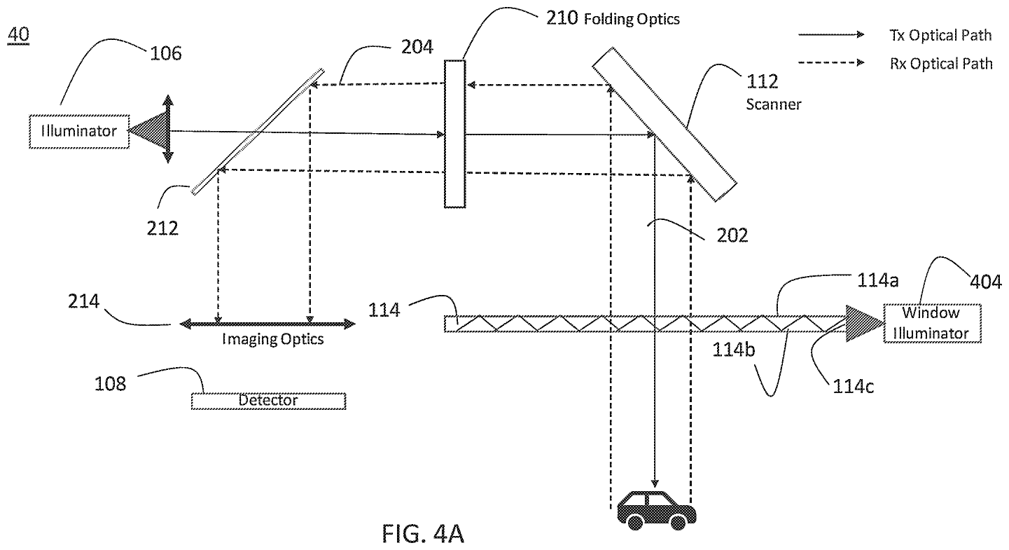

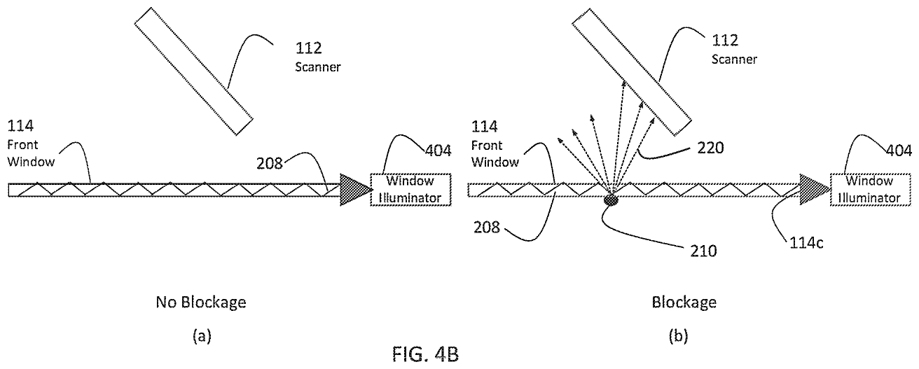

FIG. 4a schematically illustrates an example optical configuration 40 of a LIDAR system 10 of FIG. 1 with an illumination system 102 employing 2 light sources, 106 and 404. The LIDAR system may include a FOV illuminator 106 to emit light projected towards the scanner 112 via folding optics 210. Scanner 112 deflects the light through the front window 114, towards the FOV to scan the FOV along the transmitted optical path 202 (Tx), denoted by a solid line. One object in the FOV-car 200, is shown. Window illuminator 404 is configured to illuminate an edge 114c of the window 114 with edge illumination 208 of a wavelength detectable by the detector 108. The Window illuminator 404 may comprise at least one LED illuminating light, for example, with a wavelength between 820 nm and 950 nm.

The edge illumination induces Total Internal Reflection (TIR) optical phenomenon. Light waves arriving to the boundaries of window 114 (one, internal medium) are not refracted into the air (the second, external medium), but completely reflected back into the first, internal medium and stay within the window.

In order to maximize the TIR efficiency, the window 114 may have a surface roughness less than 10% of the illumination wavelength. For example, if the illumination wavelength is 905 nm, the surface roughness should be less than about 90 nm. The window illuminator 404 light source should be coupled efficiently with the window 114 to avoid losses. For example, the light source may be coupled to the window 114 using a refractive index matched adhesive or gel to minimize reflections from the edge.

The window illuminator 404 may comprise multiple light sources to inject light into the window 114 at several positions.

The window illuminator 404 may comprise light sources on one or more of the window edges. For example, the window illuminator may comprise light sources on 2 edges, 3 edges, or 4 edges, distributed along the edges of the window.

In the event that multiple blockages may be found on the window 114 simultaneously, the first blockage along the light path scatters light which may not reach a subsequent blockage (e.g. multiple raindrops on a window). Multiple light sources may be required to detect and localize multiple blockages.

In contrast with the embodiment described in FIG. 2a, the window illuminator transmission illuminates strictly the front window 114, and no other system component. Window illuminator 404 illuminates the edge 114c of front window 114 with illumination 208 such that when no blockage 210 is present on the window 114, as illustrated in FIG. 4b(a), the illumination 208 is transmitted within the window. When a blockage 210 is present on the window 114, as illustrated in FIG. 4b(b), light is scattered by the blockage. The reflected light from the blockage 220 that is captured by the LIDAR system is then deflected by the scanner 112 towards the detector 108 (not shown in FIG. 2b(b)).

The processing unit 110 may analyze the detector signals and determine the presence of an obstruction on the window 114.

In contrast with the backside illumination of the window 114 (illustrated in FIGS. 2a and 2b), TIR illumination reduces the stray light in the LIDAR system 10 since the optical path of the window illumination is limited to the window 114—unless a blockage 210 is present on the window 114.

Minimizing stray light is advantageous to avoid unwanted sources of noise, such as parasitic signals, or internal reflections in the system.

The use of TIR illumination is advantageous in discriminating between a blockage 210 on the outer surface of the window 114b, and an object (e.g., a drop of rain) close to but not in contact with the surface of the window 114. Illumination 206 projected towards the backside of the window 114 (as outlined in FIG. 2a) may be transmitted through the window. The TIR illumination 404 is confined to the window, and strictly illuminates the surface of the window 114, but not beyond, thereby effectively discriminating between a window blockage 210, and other close-range blockages.

Consistent with embodiments in the present disclosure, the window 114 may be integrated with the housing, or positioned external to the housing. For example, the LIDAR system 10 may be placed behind a protective window within a vehicle, for example a windshield or a dedicated housing for vehicle sensors. System 40 outlined in FIGS. 4a and 4b is well suited to architectures with external windows since the window illuminator 404 may be configured to be coupled with the external window (not shown in FIG. 4a). For example, the window illuminator 404 may be coupled with the LIDAR system 40 with a flexible connector and configured to be positioned at the edge of the external window to illuminate the edge of the external window to generate the required TIR illumination. For example, window illuminator 404 may be optically coupled with the external window using an optical fiber, a light pipe and/or other optical components (not shown in FIG. 4a).

One method of mitigating eye-safety risks is to implement a system with a built-in mechanism to monitor the immediate environment of the LIDAR system and reduce emissions to an eye-safe level upon detection of reflections from close-range objects in the Field of View (FOV). An exemplary eye-safety mechanism is illustrated, for example, in U.S. Pat. No. 10,281,582 assigned to the assignee of the present application, which is incorporated herein by reference.

In some eye-safety mechanisms, each time the eye-safety mechanism is activated, there is a recovery time before the system returns to full operational capacity, and the overall system performance is degraded. Overall system performance is degraded, especially in the event of a false detection.

One particular problem arises for systems that require modulated laser emissions in order to comply with laser eye safety standards (e.g., Class 1 laser safety standard). For these scenarios, discrimination between blockages on the window and near the window is required. The maximum illumination power of the illumination unit (e.g., element 102 shown in FIG. 1) may be limited by the need to make the LIDAR systems eye-safe. Damage to the human eye can occur for example, when a projected light emission from the LIDAR system enters through the eye's cornea and lens, causing thermal damage to the retina.

One method of mitigating eye-safety risks is to implement a system with a built-in mechanism to monitor the immediate environment of the system and reduce emissions to an eye-safe level upon detection of reflections from close-range objects in the FOV. Each time the eye-safety mechanism is activated, there is a recovery time before the system returns to full operational capacity, and the overall system performance is degraded. The degradation of the overall system performance is troubling especially in the event of a false detection. False detections of the presence of persons in the immediate environment of the system are commonly confused with detection of window blockages and obstructions present on or near the protective window of the system. The protective window may be part of a housing containing part or all of the LIDAR elements, or an external protective window.

LIDAR system employing integrated blockage detection according to embodiments of this disclosure (e.g., system 40 shown in FIG. 4) are well suited to discriminate between blockages situated on the window and objects near the window (i.e., within 10s of cm's from the window).

According to embodiments of the invention, trustworthy discrimination between the window blockage and an object in close vicinity (near-field) of the LIDAR may be achieved. As a result, false detection triggering of the eye safety mechanism can be avoided when there is no eye safety hazard.

In some embodiments of the invention employing two light sources (for example, as illustrated in FIG. 2a), the wavelength of the window light source 104 and the FOV light source 106 are substantially the same.

In some embodiments, the wavelength of the window light source 104 and the FOV light source 106 are both within the detection band of the light-sensitive detector.

For example, the window light source may emit near Infrared (n-IR) light. In some embodiments window light source 104 may be a Light Emitting Diode (LED) configured to emit light between 820 nanometers (nm) and 950 nm, or between 700 nm-1000 nm. In some embodiments, the light projected at a first intensity or energy and the light projected at a second intensity or energy are between about 800 nm and about 1000 nm, between about 850 nm and about 950 nm, or between about 1300 nm and about 1600 nm.

In some embodiments, the intensity or energy of the window illumination will be lower than the intensity of the FOV illumination. For example, with reference to FIG. 2a (two light sources configuration), the intensity or energy of window light source 104 emissions may be 2 times lower, 3 times lower, or 10 times lower than emissions from the FOV light source 106. The intensity or energy of the window light source 104 emissions may be a small fraction of the intensity or energy of the FOV light source emissions, for example, the intensity may be 100 times lower.

Certain light-sensitive detectors and sensors are highly sensitive and may become saturated if the intensity of the received signal is too high. The recovery time after saturation may be too long to enable effective scanning. Silicon Photomultiplier (SiPM) detectors are an example of such highly sensitive detectors. The intensity difference is thus needed to ensure that light coming from the window will be above a detection threshold, but below a level causing detector saturation. The desired energy on the detector may in the range of 0.01-10 Picojoules.

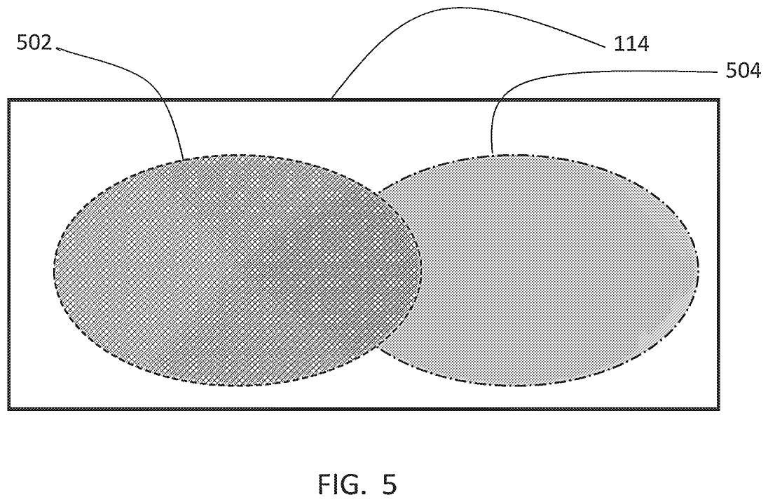

In some embodiments, the window Illumination unit 104 illuminating the back side 114a of the system window 114 as illustrated in FIG. 2a may comprise a single light source. In some embodiments, the window Illumination unit 104 may comprise multiple light sources. In some embodiments, each of the multiple light sources may illuminate a different region of the window 114. FIG. 5 illustrates a top view of the back side 114a of the system window 114. In some embodiments the system window may be illuminated by more than one blockage detection light source. For example, the window may be illuminated by 2 light sources, one of the two light sources illuminating region 502 of the window 114, and the other light source illuminating region 504 of the window 114. The illumination may be projected towards the window 114 at an illumination angle, i.e., the angle between the direction of illumination and the window 114 plane, or a vector normal to the window in the event that the window is curved or non-flat. The illumination angle may be between 0 and 60 degrees.

Various embodiments were described with reference to the use of pulsed light for FOV illumination and/or window illumination. The invention is not limited to pulsed light. For example, the FOV illumination unit 106 may project light towards the FOV by Flash illumination. A portion of the FOV may be illuminated with a flash illumination, and a different portion of the FOV, overlapping with the illuminated portion, may be deflected by the scanning unit 112 of the LIDAR system towards the light sensitive detector. Flash light may be transmitted towards the FOV without being deflected by the scanner. The light received from the FOV in response to the flash illumination is collected and deflected toward the detector via the scanner.

In some embodiments, the window Illuminator may be positioned such that it illuminates the back surface of the window at an illumination angle that is not orthogonal to the window. For example, the illumination angle may be 20 degrees-45 degrees.

In some embodiments, the window illuminator may be positioned such that it illuminates the back surface of the window, and the illumination 206 may penetrate the window and illuminate a region beyond the front surface of the window 114b. Reflections may be received from objects within the penetration depth of the illumination 206. For example, objects may be detected at a distance between 1-100 mm from the window. The detector signal may be used to determine the object distance.

Turning back to FIG. 1, attention is now drawn to the detection aspects of the present disclosure.

LIDAR system 10 is configured to detect objects (e.g., a car or a pedestrian) in the FOV located at different distances from LIDAR system 10 (could be meters or more). Objects may be a solid object (e.g., a road, a tree, a car, a person), fluid object (e.g., fog, water, atmosphere particles), or object of another type (e.g., dust or a powdery illuminated object). When the photons emitted from illumination system 102 hit an object, they are either absorbed, reflected, or refracted. Typically, only a portion of the photons reflected from object enter the window 114. As each ˜15 cm change in distance results in a travel time difference of 1 ns (since the photons travel at the speed of light to and from object), the time differences between the travel times of different photons hitting different objects may be detectable by a time-of-flight sensor with sufficiently quick response.

In some embodiments, LIDAR system 10 includes a single detector system (element 108 of FIG. 1), configured to detect reflections from both ranging emissions, and blockage detection emissions. Using a single light-sensitive detector 108 (detection system) to detect both ranging and blockages has the advantage of minimizing the number of components in the system and reducing system complexity. The use of a single detection system obviates the need for a dedicated detector and electronics, and possibly additional optical elements depending on the position of the detector in the system.

It is noted that the light-sensitive detector 108 may include a plurality of detection elements, such as Avalanche Photo Diodes (APD), Single Photon Avalanche Diodes (SPADs), combination of Avalanche Photo Diodes (APD) and Single Photon Avalanche Diodes (SPADs) or detecting elements that measure both the time of flight (TOF) from a laser pulse transmission event to the reception event and the intensity of the received photons. For example, light-sensitive detector 108 may include anywhere between 20 and 5,000 SPADs. The outputs of the detection elements in the detector may be summed, averaged, or otherwise combined to provide a unified pixel output. The invention is not limited by the type and technology of light-sensitive detector, and by its method of operation.

In some embodiments, light-sensitive detector 108 may include a plurality of detection elements for detecting photons of a light pulse reflected back from field of view and the window. The detection elements may all be included in detector array, which may have a rectangular arrangement or any other arrangement. Each detection element in the array may be aligned to detect light of a designated beam emitted by a multichannel laser. The number of detection elements in the array may be equal to the number of emitters in the multichannel laser. Detection elements may operate concurrently or partially concurrently with each other. Specifically, each detection element may issue detection information for every sampling duration (e.g., every 1 nanosecond). In one example, light-sensitive detector 108 may be a SiPM (Silicon photomultipliers) which is a solid-state single-photon-sensitive device built from an array of single photon avalanche diodes (SPADs, serving as detection elements) on a common silicon substrate. Similar photomultipliers from other, non-silicon materials may also be used. Although a SiPM device works in digital/switching mode, the SiPM is an analog device because all the microcells are read in parallel, making it possible to generate signals within a dynamic range from a single photon to hundreds and thousands of photons detected by the different SPADs. As mentioned above, more than one type of sensor may be implemented (e.g., SiPM and APD). Possibly Light-sensitive Detector 108 may include at least one APD integrated into an SiPM array and/or at least one APD detector located next to a SiPM on a separate or common silicon substrate.

According to some embodiments, measurements from each detector 108 or detection element may enable determination of the time of flight from a light pulse emission event to the reception event and the intensity of the received photons. The reception event may be the result of the light pulse being reflected from object. The time of flight may be a timestamp value that represents the distance of the reflecting object to optional optical window 224. Time of flight values may be determined by photon detection and counting methods, such as Time Correlated Single Photon Counters (TCSPC), analog methods for photon detection such as signal integration and qualification (via analog to digital converters or plain comparators) or otherwise.

In some embodiments, the sampling frequency of the signal (readout), for example, by analog to digital converters, may be modified. The Sampling frequency may be increased or decreased by the processor depending on time elapsed from light pulse emission. For example, the analog to digital converters may be configured to sample at a higher sampling frequency at a configured time to increase the resolution at a particular distance from the LIDAR System.

In some embodiments the readout sampling frequency may be increased following the second intensity (or energy) illumination emission, and prior to the next first intensity (or energy) illumination is emitted, thereby increasing the resolution of the TOF detections of window blockages.

Attention is now drawn to signal processing aspects of the present disclosure. In some embodiments, LIDAR system 10 includes a processing unit 110. The processing unit may comprise at least one processor configured to control the illumination system 102 to emit light, and coordinate operation of illumination system 102 with the operation of scanning System 112 in order to scan a field of view. Further, the processing unit 110 may receive information about reflections associated with light emission from the light-sensitive detector 108.

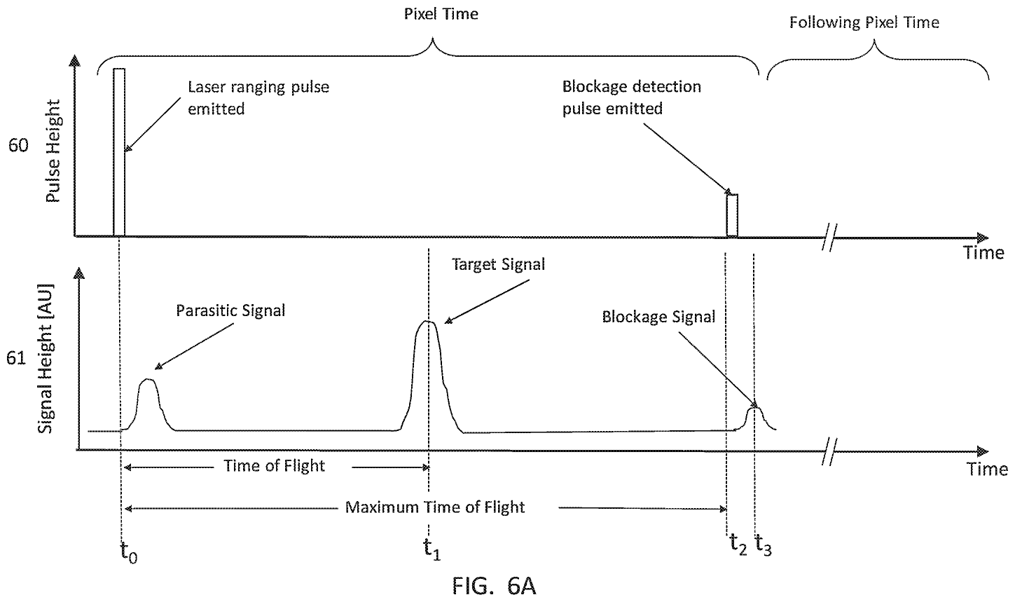

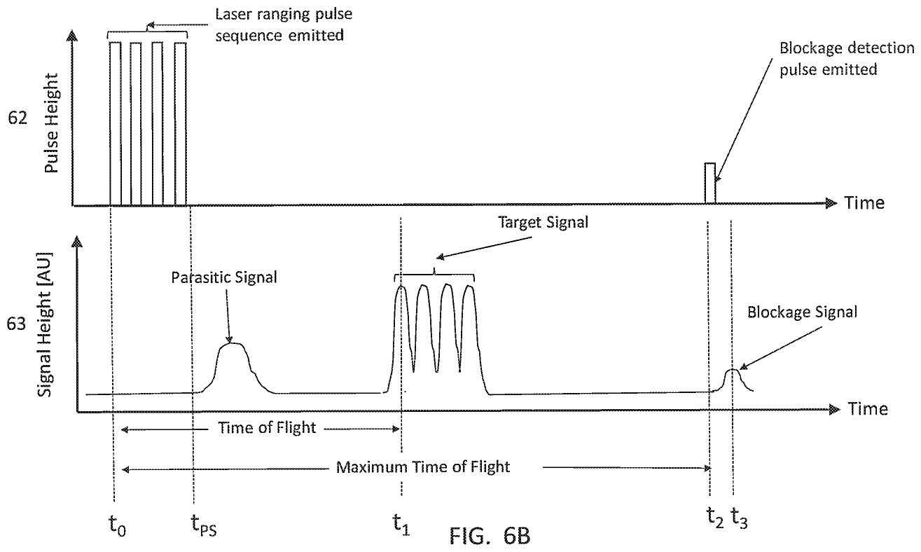

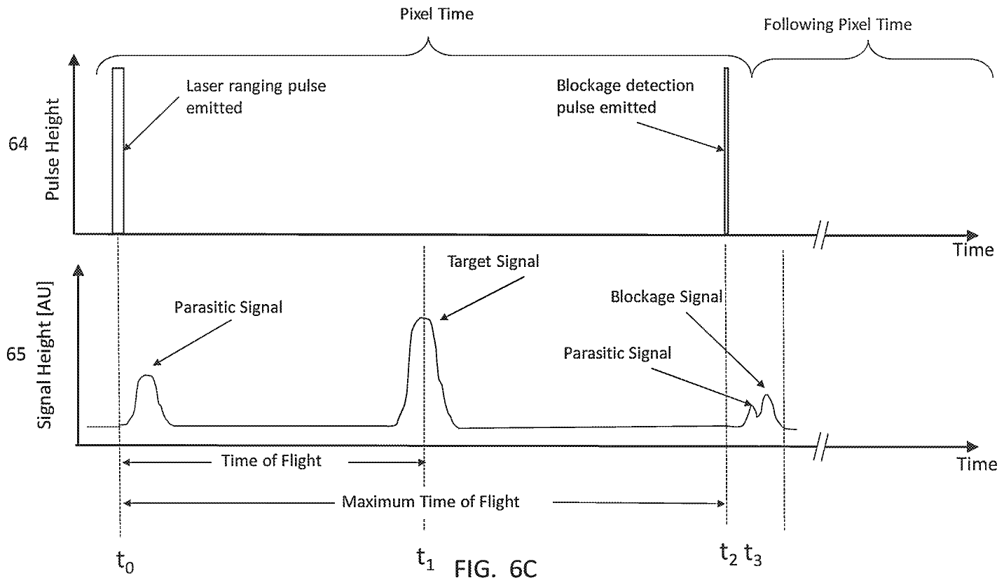

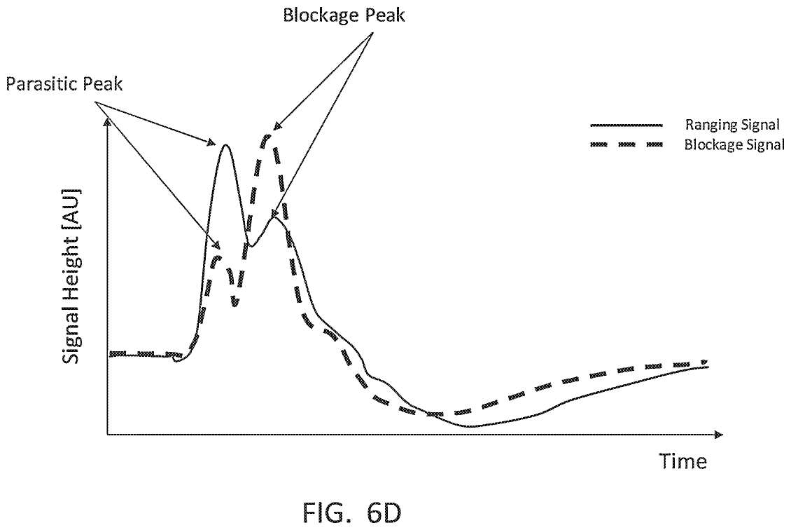

FIGS. 6A, 6B and 6C illustrate examples of emission patterns 60, 62, 64 (pulse height or width over time) and detector signal 61,63, 65 (signal height over time) that may be used for integrated blockage detection. In order to use the same detector for both ranging and blockage detection, the emission pattern must be timed so as to avoid ambiguous detections. At to, a laser ranging pulse (60, 64) or pulse sequence (62) is emitted. A parasitic signal may be detected by the detector (e.g., due to reflections from the emitted pulse from optical elements in the system, or the system window 114). At t₁ a target signal (61, 63, 65) at an arbitrary distance is detected, indicating that an object in the FOV is identified. The Time of Flight (TOF) (t₁-t₀) may be used to determine the distance of the object from the LIDAR system. The orientation of the scanning system may be used to determine the pointing direction of the emission, and the position of the detected object in the FOV. After a predetermined time interval that may be defined by the maximum range of the system (indicated as Pixel time), the system may repeat and emit another ranging pulse during the following pixel time.

For example, if the maximum range of the system is configured to 300 meters, it takes 2 microseconds (μs) for light (Speed 3×10⁸ m/s) to travel to and from a target located 300 m from the LIDAR system. In this example, the Maximum Time of Flight (t₂−t₀) may be defined as 2 μs. If a sequence of pulses is emitted, the time t₂−t₀ may be increased by the duration of the pulse sequence emissions. FIG. 6B illustrates the pulse sequence duration (t_{PS}−t₀), in which case the Maximum Time of Flight may be defined as 2 μs+(t_{PS}−t₀).

In examples of FIGS. 6A, 6B and 6C, a blockage detection pulse (or sequence of pulses) is emitted at t₂, after the Maximum Time of Flight, and prior to the emission of the subsequent ranging pulse during the following Pixel Time. The blockage detection pulse may have a lower pulse height (i.e. lower intensity, lower peak power) than the ranging pulse as illustrated in FIGS. 6A (60) and 6B (62), or may have a shorter duration than the ranging pulse as illustrated in FIG. 6C (64). If a blockage is present on or near the window at the instantaneous field of view associated with the instantaneous position of the light deflector, a blockage signal will be detected at t₃. The time between the blockage detection pulse and the received signal (t₃−t₂) is almost immediate. The duration between the pulse emission and detection will be the pulse width (i.e., duration). In the case of pulse sequence, the total duration includes the duration of any pulse repetitions required for a pulse sequence. The time of flight from the light source to the window and back to the detector, such that a misdetection will be easily detected if this time interval is inaccurate. For example, the t₃−t₂ may be 50 ns, 100 ns, 300 ns, 500 ns, or more. For example, the t₃−t₂ may be between 100 ns and 400 ns. At t₃, if no signal is detected it may be concluded that the window is free of obstructions at window position towards which the scanner was pointing when the blockage detection pulse was emitted.

Since the blockage detection pulse is emitted after the Maximum Time of Flight of the system, the likelihood of a target signal resulting from reflections from the FOV coinciding with the Blockage signal is greatly reduced, increasing reliability of the results, and reducing ambiguous detections.

Although the blockage pulse has a lower energy than the laser pulse, a parasitic signal may be detected by the detector, as illustrated in FIG. 6C (65). As illustrated, the Blockage signal and parasitic signal may be almost simultaneous but may be distinguished.

FIG. 6D illustrates the detector response to reflections of a ranging light pulse (i.e. a high energy pulse), referred to as Ranging Signal, and the detector response to reflections of a blockage detection light pulse (low energy pulse, e.g. a shorter pulse width or a lower intensity pulse), referred to as Blockage signal. The Ranging Signal (solid line) and the Blockage signal (dashed line) are presented overlaid to illustrate the differences in the signal features. These signals are each emitted at separate time intervals and do not impact one another. The first peak in the ranging signal and blockage signal (referred to as Parasitic Peak) results from light reflected from optical elements in the optical path of the LIDAR system, including the window 114. In this example, the second peak in the ranging signal and blockage signal (referred to as Blockage Peak) results from light reflected from a blockage object at a distance of 1.5 meters from the LIDAR system. The Blockage Peak of the Ranging Signal—which is lower than the Parasitic Peak of the Ranging signal—may be interpreted as noise and may not be adequately separated from the Parasitic Peak of the Ranging signal, to thereby contribute to higher false negative detection of window blockage. The Blockage signal has a higher blockage peak—higher comparing the Parasitic Peak of the Blockage signal as well as higher than the Parasitic Peak of the Ranging signal and thus can be better distinguished from the parasitic peak, enabling detection of blockages with higher confidence. This is due to the lower energy of the blockage detection pulse, generating a lower parasitic peak from which the light sensitive sensor recovers from with a faster recovery time. Due to the faster recovery time, the detector is operational when the reflections of the blockage detection pulse impinge on the detector (immediately following the parasitic peak). This is in contrast with the detector response to the ranging signal, which saturates the detector with the parasitic peak, and requires a longer recovery time. As such, the detector is less sensitive to reflections from the blockage object in response to the ranging pulse.

Attention is now drawn to controlling aspects of the present disclosure. In some embodiments, the processor 110 shown in FIG. 1 controls the Illumination system 102 to emit ranging illumination and blockage detection illumination sequences to avoid reflections of ranging and blockage illumination received by the detector simultaneously.

In some embodiments, the processor 110 controls the illumination system to emit ranging illumination before a first time-interval defined by the maximum time of flight of the system and emit blockage detection illumination before a second time interval, where the first and second time intervals do not overlap.

In some embodiments, the processor 110 controls the illumination system to emit ranging illumination before a first time interval defined by the maximum time of flight of the system, and emit blockage detection illumination before a second time interval, where the second time interval immediately follows the first time interval.

In some embodiments, the blockage detection emission pulse may be emitted during the maximum time of flight duration. However, a signal on the detector received between the blockage detection pulse t₂ and the maximum time of flight duration (t₁−t₀) may either be as a result of a relatively distant object in the FOV, or a blockage on the window 114. To avoid such ambiguous detections, the processor may control the illumination unit to emit the blockage detection signal at t₂, following the maximum time of flight t₁−t₀ (t₂>t₁−t₀). In some embodiments, the blockage detection emissions pulse scheme is controlled such that object reflection signals and blockage detection reflections are not received on the detector simultaneously. In some embodiments, the processing unit 110 controls the illumination system to emit one or more ranging pulses, pause emissions for a duration of up to maximum time of flight of the system, and subsequently emit one or more blockage detection pulses. In some embodiments, the processor receives electric signals from the light-sensitive detector reflected from ranging light emissions and blockage detection emissions.

In some embodiments, the processor 110 controls the illumination system to emit blockage detection illumination pulses each time a ranging pulse is emitted. In some embodiments, the processor controls the illumination system to emit blockage detection illumination after a number of illumination pulses. For example, the illumination system may emit a blockage detection pulse after 2, 3, 4, or 5 ranging pulses.

In some embodiments, the processor 110 controls the blockage detection pulse emission frequency with a dependency on the instantaneous position of the light deflector. For example, the frequency of blockage detection pulse emission may be higher in the center of the FOV (commonly referred to as a region of interest, ROI) than in the periphery of the FOV.

In some embodiments, the processor may distinguish between detector signals resulting from reflections from blockage detection emissions using the characteristics of the emissions. For example, the processor may identify blockage detection signals by the number or the sequence pattern of emitted pulses, or the pulse shape (width, height). In another example, the processor may identify blockage detection using the time the signal was received after the emission. In some embodiments, the processing unit 110 may control the blockage detection light source to emit a single pulse. In some embodiments, the processing unit 110 controls the blockage detection light source to emit a series of pulses. The duration of time required to detect a blockage scales with distance. Since window blockages are at a short distance from the detector, blockage detection pulses have a low impact on overall availability of the detector. In some embodiments, the processing unit 110 controls the width of the pulse emitted by the blockage detection light source. In some embodiments, the processing unit 110 controls the Intensity or energy of the pulse emitted by the blockage detection light source.

In some embodiments, the processing unit 110 may determine reflections from blockage detection emissions based on the time at which the signal was detected by the Light-sensitive detector 108. The processor may determine a blockage based on a signal detected within the time interval t₃−t₂. The processor may determine a blockage based on a maximum signal detected at t₃, which may be a known value depending on the pulse width and window 114 position.

In some embodiments, the sensitivity of the light sensitive detector may be reduced following t₂ to avoid saturation of the detector by reflections resulting from the blockage detection illumination.

In some embodiments, the processing unit 110 may determine reflections from blockage detection emissions based on the characteristics of the received signal. For example, the processor may identify blockage detection signals by the number of pulses, the sequence pattern of the pulses, the pulse shape (e.g. width, height). In some embodiments, the processor may identify a blockage detection signal using the time the signal was received after the emission.

In some embodiments, the processing unit 110 may determine reflections from blockage detection emissions based on the time at which the signal was detected by the Light-sensitive detector 108 and the shape of the signal detected. A parasitic signal may be detected, and a parasitic signal with an additional peak (Blockage signal, as illustrated in FIG. 6C) may indicate a blockage a reflection. The distance between the parasitic peak and the Blockage Signal may enable the processing unit 110 to determine the position of the blockage (e.g. on the window, or at a short-distance from the window). The processor may determine a blockage based on a signal detected within the time interval t₃−t₂. The processor may determine a blockage based on a maximum signal detected at t₃ which may be a known value depending on the pulse width and window 114 position.

In some embodiments, the processing unit 110 may determine the presence of a blockage based on a combination of properties of the parasitic signal resulting from a ranging signal and the Blockage signal reflections resulting from blockage detection emissions towards the same direction.

In some embodiments, the processing unit 110 may determine the precise location of a blockage on the system window 114. The processing unit 110 may receive signals from the light-sensitive detector 108, information about the position and orientation of scanning system 112, or ‘pointing direction’ at the time the blockage detection pulse was emitted or at the time the reflection was received, and use received signals to determine the position on the window associated with the signals indicating a detected blockage.

In some embodiments, the processing unit may generate a data point in a point-cloud, including a target position in the FOV (if a target is detected), and additional information. The additional information may include reflectivity and blockage information. For example, pixel blockage information may include a blockage indicator (blocked/unblocked), a percent blockage of the pixel, percent transparency of the blockage, or any other characterization of the obstruction blocking the pixel.

In some embodiments, the associated scanning angles (‘pointing direction’ or instantaneous position of the light deflector) may be reported to an external system. In the event that the exterior window position is unknown, an external processor may receive the pointing direction of the scanner and use the pointing direction and window position to determine the location of the blockage on the window.

Attention is now drawn to operations relying on blockage detection according to embodiments of the present disclosure.

In some embodiments, the processing unit 110 may identify the object (e.g. classify a type of object such as water, mud, road grime, snow, rain, dust, salt, bug debris, pollen, or bird droppings, etc.); determining a composition of an object (e.g., solid, liquid, transparent, semitransparent); determining a kinematic parameter of an object (e.g., whether it is moving, its velocity, its movement direction, expansion of the object).

In some embodiments, in the event of a blockage detection the detected blockage position may be reported to an external system, for example a vehicle Central Processing Unit (CPU) or a cleaning system.

In some embodiments, the processing unit 110 may identify the size of the blockage. For example, the size of the object may be determined using the light-sensitive detector signals. If the at least one light-sensitive detector 108 includes a detector array, the portion of the array detecting a signal may enable the size of the blockage to be determined. In some embodiments, multiple detections adjacent to one another may be used to determine the size of the blockage.

In some embodiments, the type of obstruction may be determined, and one or more remedial actions may be taken. For example, in some cases, an obstruction pattern may be detected by the system, and based on this pattern, the system may classify the obstruction and implement a process for cleaning the obstruction based on the classification and/or location on the window. For example, based on the detection and/or classification of the obstruction pattern, the system may modify an illumination scheme, a scanning scheme, a detection scheme or any other operational parameters of the system based on the results of the analysis of the obstruction.

In some embodiments, based on the detection and/or classification, the system may generate a recommendation for a cleaning mode. For example, a cleaning system may comprise a wet cleaning option, using cleaning fluid or water sprayed onto the window. A system may comprise a dry cleaning option, using pressurized air released on the window. Based on the blockage type, one mode may be more effective than the other. In some embodiments, the system may recommend a cleaning mode based on for example, the blockage type, size and more.

In some embodiments, the cleaning system may be activated to clean the blockage location, or a sector including the blockage on the window 114. For example, the cleaning system may spray liquid from nozzle(s) closest to the blockage or activate mechanical means where the blockage is located. Activating the cleaning system only in response to blockage detection and optionally blockage classification may reduce the recovery time required after the operation of the cleaning system the LIDAR system returns to full operational capacity. For example, if the window is only partially cleaned, the LIDAR system may continue to emit light and perform measurements through the unaffected portion of the window.

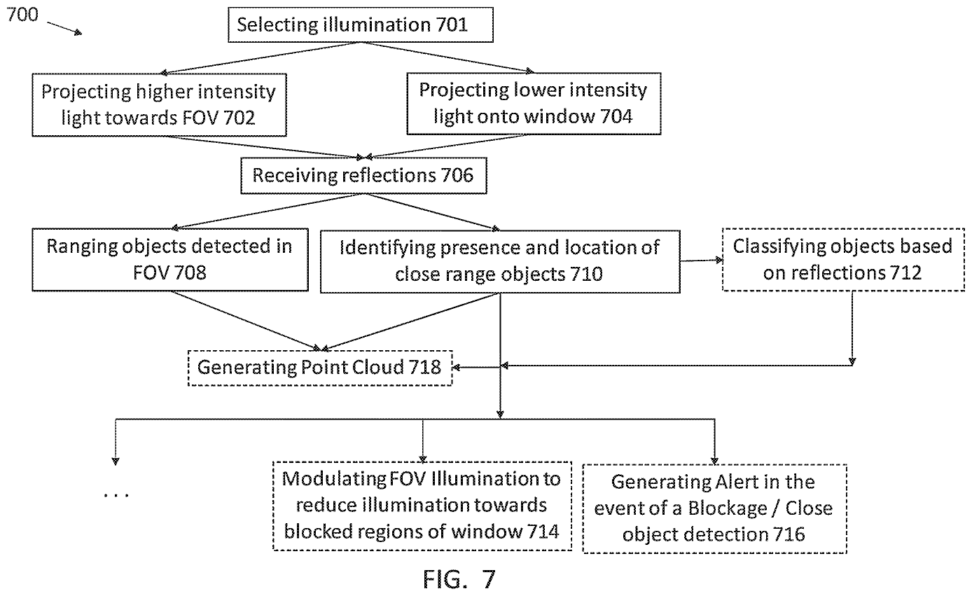

FIG. 7 is a flow chart describing a method 700 for detecting and classifying obstructions. Method 700 may be performed by systems for example, as illustrated in FIGS. 1, 2a, 3 and 4a. In operation 701—selecting illumination for FOV illumination or window illumination. In the case of a system employing a single illumination source, operation 701 may include selecting between two illumination modes. For example, the processing unit 110 may control the illumination system 102 to select an illumination mode. In the case of a system employing two (or more) light sources, operation 701 may include selecting one source for FOV illumination and another source for window illumination.

In operation 702—projecting higher intensity light towards FOV. The illumination system 102 emits ranging illumination towards the FOV. The ranging illumination may be an emission pattern projected towards a FOV in a single time frame for a single portion of the field of view associated with an instantaneous position of at least one light deflector. In operation 704—projecting lower intensity light onto the protective window. As explained with reference to FIG. 2a, operation 704 may including illuminating the protective window with backside illumination. As explained with reference to FIG. 3, operation 704 may include using modulating unit, e.g. a laser driver, to modulate the illumination unit configured to trigger the laser to emit laser pulses with different energy levels for illuminating the short-range—the window and its vicinity. As explained with reference to FIG. 4a, operation 704 may include illuminating the protective window with edge illumination, giving rise to TIR phenomenon, scattering light exclusively when window is obstructed.

Operations 704 may include projecting lower intensity light, or pulses of light with a lower overall energy (e.g. shorter pulse width, or lower intensity, or a combination of both).

In operation 706—Receiving reflections: the received reflections may include reflections from the FOV, in response to illuminating the FOV with the higher intensity or higher energy illuminations or ‘ranging’ illumination, and reflections from the window and its vicinity, in response to illuminating the window with the lower intensity or lower energy light (i.e. ‘blockage detection’ illumination).

In operation 708—ranging objects detected in FOV. The signal received by detector 110 may be analyzed to range objects in the FOV. Ranging of an object in the FOV may include determining the three-dimensional position of the object with respect to a reference position. Ranging an object in the FOV may further include determining additional properties of the detected object such as reflectivity, velocity, etc. The ranging information may be used to generate a point cloud data point representative of the determined location of the detected object point.

In operation 710—Identifying presence and location of close-range objects. For example, it may be determined if the close-range objects are positioned on the window 114, or close to the window. The precise location of the object on the window may further be determined, as described above.

In optional operation 712—classifying objects based on reflections. For example, the objects may be classified by type, category, or property, as described above.

If a blockage or close-range object is detected, an alert may be generated in optional operation 716. The alert may be reported to an external system, for example a vehicle CPU or a cleaning system. The alert may include information about the blockage, e.g. the blockage type, position, a recommended remedial action, etc. In addition, in optional operation 714, the Illumination system may modulate emissions to reduce illumination towards the blocked regions of the FOV. Additional operations may be carried out based on the detection and optionally the classification of window obstructions.

In optional operation 718, a point cloud may be generated based on the object information that is generated in operation 708. Window obstruction information may also be represented in the point cloud.

Method 700 may be implemented by projecting light at a first intensity 702 and a second intensity lower than the first intensity 704. Method 700 may be implemented in an equivalent manner by projecting light at a first energy and a second energy lower than the first energy. Method 700 may be implemented by projecting pulsed illumination emitted at a first pulse width and a second pulse width shorter than the first pulse width. Method 700 may be implemented by projecting a first light and a second light, wherein the first light differs from the second light by at least one illumination parameter as described herein.

Thus, broadly described, method 700 may comprise, in operation 701, selecting illumination and/or illumination parameters, wherein the illumination parameters comprise one or more of light energy, light intensity, peak power, average power, light wavelength, pulsed light form, pulsed light duration, pulsed light timing; in operation 702, project first light, with first illumination parameters, toward the FOV; in operation 704, project second light, with second illumination parameters, onto the window, wherein the second illumination parameters differ from the first illumination parameters in at least one illumination parameters.

The information from the at least one light-sensitive detector (i.e., each pixel) represents the basic data element from which the captured field of view in the three-dimensional space is built. This may include, for example, the basic element of a point cloud representation, with a spatial position and an associated reflected intensity value.

In some embodiments, sensor signals may be used by processing unit 110 to generate a point cloud, wherein each point in the point cloud may include a parameter indicating its blockage status (e.g., blocked, partially blocked, or clear). The blockage status may be determined using blockage classification information, or any other available information. Other window obstruction information may be included in each point, including parameters such as: % blockage of the pixel (e.g., if part of the pixel region on the window is blocked and part is transmitted, the percent may indicate the relative portion that is blocked), percent transparency of the blockage (100% may be full transmission, 0% may indicate an opaque blockage), or any other characterization of the obstruction.

The point cloud may undergo further processing by additional algorithms, and or neural network or machine learning software. Each LIDAR FOV frame includes multiple pixels captured throughout the scan of the FOV. LIDAR FOV frames are further processed to identify and classify objects in the FOV. Blockage information may enable better neural network performance by, for example, by weighing un-blocked pixels higher than blocked or partially blocked pixels. The confidence levels of object identification and classification may be further improved.

In some embodiments, several pixel measurements (and related sets of sensor signals) may be used by the processing unit 110 to determine a size of a blockage. For example, if four consecutive measurements are fully blocked, it may be deduced that a single blockage is obstructing these four positions, and the size of the blockage may be estimated or calculated. This may be calculated on a pixel-by-pixel basis, by storing previous pixel blockage information. This information may be calculated on a frame-by-frame basis by binning or clustering the blocked pixels to further characterize the scene.

In some embodiments, several sensor signals may be used for a single pixel measurement, such that multiple reflections at varying distances may be detected. In these cases, a certain sub-pixel region may be partially blocked, or blocked by a semi-transparent blockage, and the un-blocked portion may be included in the point cloud.

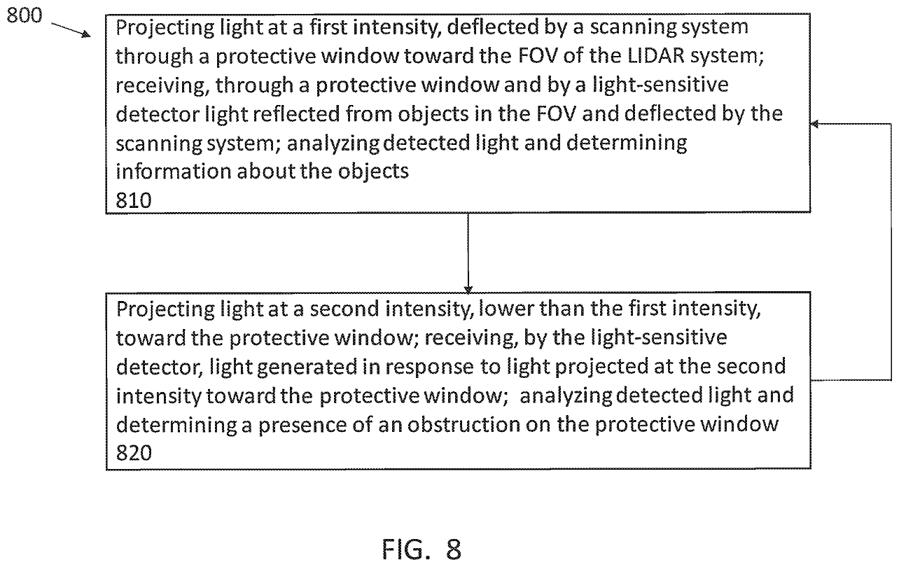

FIG. 8 is a flowchart describing a method 800 for surveying a Field of View (FOV) by a LIDAR system.

Method 800 comprises, in operation 810: projecting light at a first intensity, deflected by a scanning system through a protective window toward the FOV of the LIDAR system; receiving, through a protective window and by a light-sensitive detector light reflected from objects in the FOV and deflected by the scanning system; analyzing detected light and determining information about the objects.

Method 800 further comprises, in operation 820, projecting light at a second intensity, lower than the first intensity, toward the protective window; receiving, by the light-sensitive detector, light generated in response to light projected at the second intensity toward the protective window; analyzing detected light and determining a presence of an obstruction on the protective window.

Method 800 may comprise projecting light at a first energy, deflected by a scanning system through a protective window toward the FOV of the LIDAR system; and projecting light at a second energy, lower than the first energy, toward the protective window. The energy of the projected light may be reduced by emitting light at a lower intensity, or by emitting light for a shorter duration (shorter pulse width), or a combination of both.

According to embodiments of the invention, the light projected at a first intensity and the light projected at a second intensity are between 700 nm-1000 nm.

The projecting light at the first intensity toward the protective window may comprise generating one or more light pulses. The projecting light at the second intensity toward the protective window may comprise generating one or more light pulses.

The projecting light at a first intensity toward the FOV and the projecting light at a second intensity toward the protective window may be done in non-overlapping time intervals such that light reflected from the field of view and light received in response to projecting light toward the protective window arrive to the detector in non-overlapping time intervals. For example, at least one of the projecting light at a first intensity toward the FOV and the projecting light at a second intensity toward the protective window may comprise generating a sequence of non-overlapping light pulses.

The light at the higher first intensity (projected toward the FOV) and the light at the lower intensity (projected toward the protective window) may differ not only in their intensity but also in one or more parameters from a group consisting of: wavelength, form, pulse duration and width.

Method 800 may be implemented by projecting light at a first intensity 810 and a second intensity lower than the first intensity 820. Method 800 may be implemented in an equivalent manner by projecting light at a first energy and a second energy lower than the first energy. Method 800 may be implemented by projecting pulsed illumination emitted at a first pulse width and a second pulse width shorter than the first pulse width. Method 800 may be implemented by projecting a first light and a second light, wherein the first light differs from the second light by at least one illumination parameter as described herein.

Thus, broadly described, method 800 may comprise, in operation 810, projecting first light with first illumination parameters, deflected by a scanning system through a protective window toward the FOV of the LIDAR system; receiving, through a protective window and by a light-sensitive detector first light reflected from objects in the FOV and deflected by the scanning system; analyzing detected first light and determining information about the objects; in operation 820, projecting second light with second illumination parameters toward the protective window; receiving, by the light-sensitive detector, second light reflections in response to light projected at the second intensity toward the protective window; analyzing detected second light reflections and determining a presence of an obstruction on the protective window, wherein the illumination parameters comprise one or more of light energy, light intensity, peak power, average power, light wavelength, pulsed light form, pulsed light duration, pulsed light timing, and wherein the second illumination parameters differ from the first illumination parameters in at least one illumination parameters.

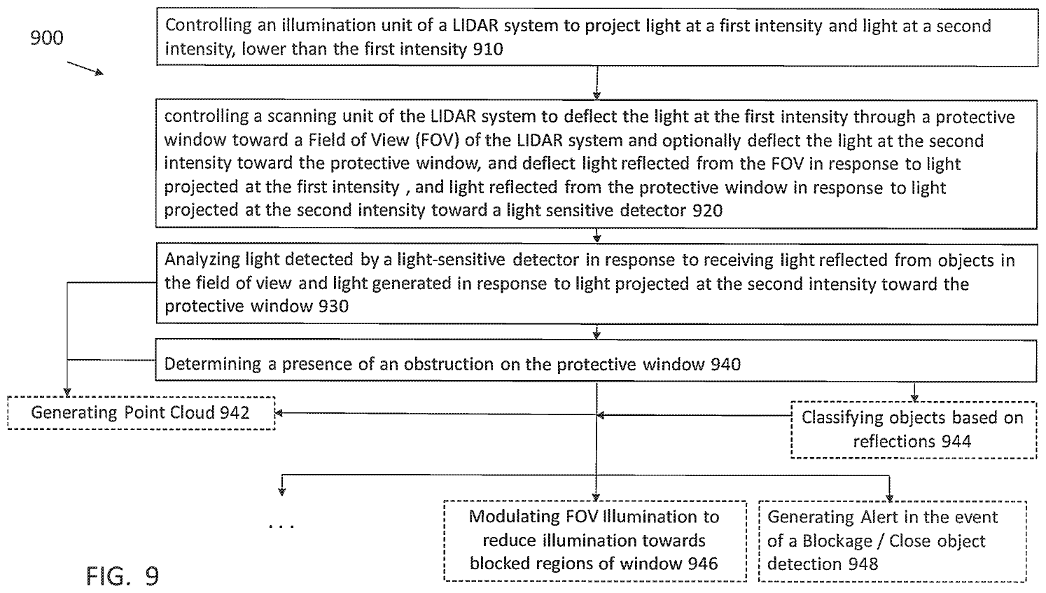

FIG. 9 is a flowchart of a method 900 for surveying a field of view according to some embodiments of the invention. Method 900 may be executed by the at least one processor, for example processing unit 110 discussed with reference to FIGS. 1, 2a, 3 and 4a.

In operation 910—Controlling an illumination unit of a LIDAR system to project light at a first intensity and light at a second intensity, lower than the first intensity. According to some embodiments, operation 910 involves controlling a single light source between two (or more) illumination modes. According to other embodiments, operation 910 involves controlling at least two light sources. Operation 910 may further involve controlling additional illumination parameters as described above.

In operation 920—controlling a scanning unit of the LIDAR system to deflect the light at the first intensity through a protective window toward a Field of View (FOV) of the LIDAR system and optionally deflect the light at the second intensity toward the protective window, and deflect light reflected from the FOV in response to light projected at the first intensity, and light reflected from the protective window in response to light projected at the second intensity toward a light-sensitive detector.

In operation 930—analyzing reflection signals-light detected by a light-sensitive detector in response to receiving light reflected from objects in the field of view and light generated in response to light projected at the second intensity toward the protective window. Reflections signals may include indications of light reflected from the protective window, light reflected from a blockage or obstruction on the protective window, and light reflected from objects in the field of view and passing through the protective window prior to impinging on light-sensitive detector.

In operation 940—determining a presence of an obstruction on the protective window. The determination may be based on the shape, the time, or any other information available to the processor of the reflection signals.

In optional operation 942—generating Point Cloud, including blockage information per pixel, as discussed above.

In optional operation 944—classifying objects based on reflections, as discussed above.

In optional operation 946—modulating FOV Illumination to reduce illumination towards blocked regions of window. In optional operation 948—generating alert in the event of a Blockage/Close object detection. Additional operations may be carried out based on the detection and optionally the classification of window obstructions.

Method 900 may be implemented by projecting light at a first intensity and a second intensity lower than the first intensity. Method 900 may be implemented in an equivalent manner by projecting light at a first energy and a second energy lower than the first energy. Method 900 may be implemented by projecting pulsed illumination emitted at a first pulse width and a second pulse width shorter than the first pulse width. Method 900 may be implemented by projecting a first light and a second light, wherein the first light differs from the second light by at least one illumination parameter as described herein.

Thus, broadly described, method 900 may comprise, in operation 910, controlling an illumination unit of a LIDAR system to project first light with first illumination parameters and second light with second illumination parameters, wherein the illumination parameters comprise one or more of light energy, light intensity, peak power, average power, light wavelength, pulsed light form, pulsed light duration, pulsed light timing, and wherein the second illumination parameters differ from the first illumination parameters in at least one illumination parameters; in operation.

Based on information about the window blockage, the processing unit may output information instructing one or more systems within the LIDAR system and/or vehicle to execute a remedial action. For example, an obstruction clearing module may control activation parameters of one or more cleaning mechanisms, e.g., wipers, washing fluid, pressurized air, etc. In another embodiment, obstruction clearing module may alert an operator of the vehicle or another system (e.g., host) of the detected obstruction and/or type of obstruction, or a recommended remedial action.

In some embodiments, obstruction clearing module may instruct a system of the system 10 and/or vehicle to execute the remedial action of cleaning a protective window, e.g., window 114 or windshield. In some embodiments, the remedial action may include a window cleaning request. For example, the window cleaning request may instruct a wiper system to clear the protective window 114 of the system 10. In some embodiments, the processor may be configured to output information that includes a window cleaning request associated with a determined cause of the obstruction of the protective window based on the obstruction classification.

In some embodiments, the processor may be configured to select a cleaning process associated with the determined cause of the obstruction of the protective window, and to output information that includes a window cleaning request associated with the selected cleaning process. For example, obstruction classification module may classify a detected obstruction as having an obstruction pattern matching dust. Based on this obstruction pattern, obstruction clearing module may send instructions to a system of the system 10 or vehicle to spray compressed air, or washing fluid on the protective window and to activate one or more wipers.

In some embodiments, the processor may be configured to output information that includes a window cleaning request associated with a determined position of the obstruction on the protective window as discussed above.

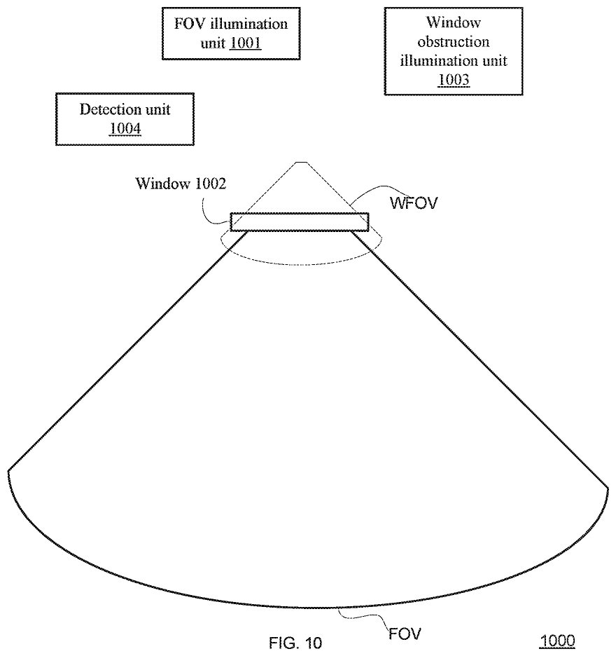

FIG. 10 is an example of a LIDAR system 1000 for surveying a field of view (FOV). LIDAR system 1000 may include:
a. FOV illumination unit 1001 that is configured to illuminate at least a part of the FOV with first light, the first light passes through a window 1002.
b. Window obstruction illumination unit 1003 that is configured to illuminate at least a part of a window field of vision (WFOV) with second light. The WFOV includes at least a part of the window. The WFOV has a shorter range than the FOV—and it (the WFOV) may be much smaller than the FOV. The first light differs from the second light by at least one illumination parameter. The difference may allow to distinguish between the first light and the second light.
c. Detection unit 1004 that is configured to (i) detect first reflected light that is reflected from one or more objects within the at least part of the FOV, as a result of the illumination of the at least part of the FOV with the first light; and (ii) detect second reflected light from the at least part of the WFOV, as a result of the illuminating the at least a part of the WFOV with second light.

The at least one illumination parameter may include at least one of: light energy, light peak power, light intensity, pulsed light form, pulse light duration, pulsed light timing, or light wavelength. For example—the at least one illumination parameter may include light energy, and wherein a light energy of the second light is lower than a light energy of the first light. Each one of the first light and the second light may have a wavelength between 700 nm-1000 nm. Other wavelengths may be provided. The second light may include one or more second light pulses. The first light may include one or more first light pulses.

The detection unit may be configured to detect the first reflected light and detect the second reflected light during non-overlapping periods.

Window obstruction illumination unit 1003 may be configured to illuminate the at least part of the WFOV with the second light at a second timing, and wherein the FOV illumination unit 1001 is configured to illuminate the at least part of the FOV with the first light at a first timing to guarantee that the detection unit 1004 detects the first reflected light and detect the second reflected light during non-overlapping periods. The WFOV may cover the window and the vicinity of the window—for example up to 1, 5, 10, 15, 20, 30, 40, 50, 60 millimeters from the window—even a few centimeters and/or a few decimeters from the windows—and the like.

The window obstruction illumination unit 1003 may be configured to project a sequence of non-overlapping second light pulses. The FOV illumination unit 1001 may be configured to project a sequence of non-overlapping first light pulses.

It should be noted that although various examples of LIDAR system that appear in the specification and drawings include a scanning unit that deflects light—that the FOV (or at least a part of the FOV) may be first illuminated without a scanning unit—for example by moving the detection unit in relation to the FOV, and/or moving the FOV illumination unit in relation to the FOV.

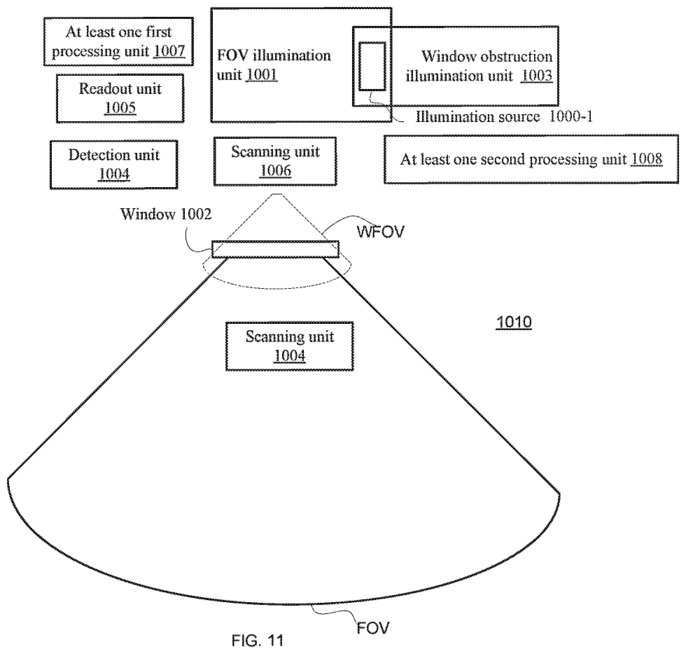

FIG. 11 illustrates LIDAR system 1010 that includes FOV illumination unit 1001, window 1002, window obstruction illumination unit 1003, detection unit 1004, readout unit 1005, scanning unit 1006, at least one first processing unit 1007, at least one second processing unit 1008. It should be noted that the LIDAR system may include only one or some of the readout unit 1005, the scanning unit 1006, the at least one first processing unit 1007, and the at least one second processing unit 1008.

The at least one first processing unit 1007 may differ from the at least one second processing unit 1008. The at least one first processing unit 1007 may be the at least one second processing unit 1008. The at least one first processing unit 1007 may share at least one processing unit with the at least one second processing unit 1008—or may not share any processing unit with the at least one second processing unit 1008.

The readout unit 1005 is configured to sample detections signals generated by the detection unit. For example—readout unit 1005 may be configured to sample first detection signals generated by the detection unit in response to the first reflected light at a first sampling rate that exceeds a second sampling rate of second detection signals generated by the detection unit in response to the second reflected light.

The scanning unit 1006 may be used to deflect the second reflected light towards the detection unit. The scanning unit may or may not be used to deflect the first reflected light towards the detection unit.

The at least one first processing unit 1007 may be configured to perform at least one of the following:
a. Determine FOV object information about the one or more objects.
b. Generate depth information regarding the objects based on detection signals generated by the detection unit in response to the first reflected light.

The at least one second processing unit 1008 may be configured to perform at least one of:
a. Determine WFOV obstruction information.
b. Generate window obstruction information based on detection signals generated by the detection unit in response to the second reflected light.
c. Communicate window obstruction information that is indicative of a presence of a blockage.
d. Affect an operating parameter of the FOV illumination unit when an obstruction is detected. For example—affect a value of an illumination parameter of the first light.
e. Generate window obstruction information also in view of at least one of an angle of illumination of the second light, a position information of a deflector that deflected the second reflected light towards the sensing unit, an intensity of the second light, and a second light detection time information.

The window obstruction information may include at least one of: a blockage indicator, pixel area blocked percent, or a blockage transparency. The window obstruction information may include at least one information item out of a location of the obstruction on the window, a size of the obstruction, a shape of the obstruction, a transparency of the obstruction.

In FIG. 11, the FOV illumination unit 1001 and the window obstruction illumination unit 1003 share an illumination source 1000-1.

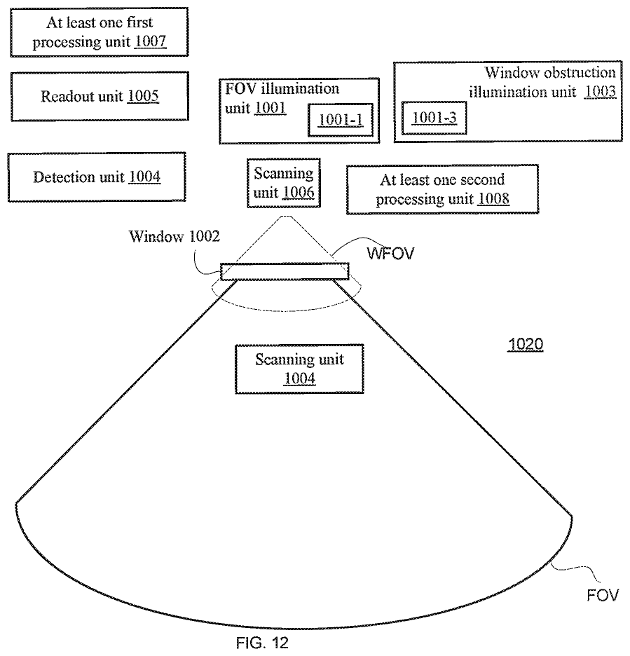

FIG. 12 illustrates a LIDAR system 1020 in which the FOV illumination unit 1001 may include FOV light source 1001-1 and the window obstruction illumination unit 1003 may include a window light source 1003-1.

The window light source 1003-1 may be configured to illuminate a backside of the window 1002 at one or more illumination angles. Alternatively—the window light source 1003-1 may be configured to illuminate the window through an edge of the window.

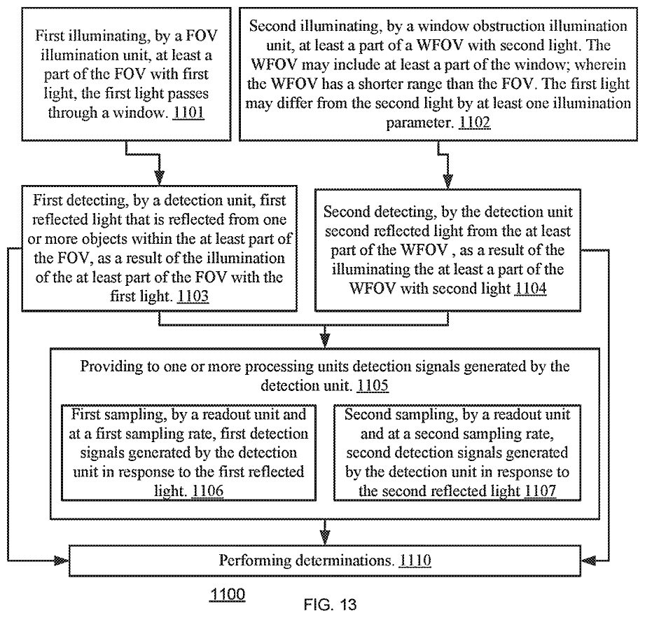

FIG. 13 illustrates an example of method 1100 for surveying a first Field of View (FOV) by a LIDAR system.

Method 1100 may include steps 1101 and 1102.

Step 1101 may include first illuminating, by a FOV illumination unit, at least a part of the FOV with first light, the first light passes through a window.

Step 1101 may include at least one of:
a. Projecting a sequence of non-overlapping first light pulses.
b. Illuminating by a FOV light source of the FOV illumination unit.
c. Illuminating by light source that is shared by the window obstruction illumination unit and by the FOV illumination unit.

Step 1102 may include second illuminating, by a window obstruction illumination unit, at least a part of a WFOV with second light. The WFOV may include at least a part of the window; wherein the WFOV has a shorter range than the FOV. The first light may differ from the second light by at least one illumination parameter.

Step 1102 may include at least one of:
a. Projecting a sequence of non-overlapping second light pulses
b. Second illuminating by a window light source of the window obstruction illumination unit.
c. Illuminating by light source that is shared by the window obstruction illumination unit and by the FOV illumination unit.
d. Illuminating, by the window light source, a backside of the window at one or more illumination angles.
e. Illuminating, by the window light source, the window through an edge of the window.

Steps 1101 and 1102 may be overlapping or non-overlapping. The terms “first illuminating” and “second illuminating” merely provide a distinction between the illuminating by the FOV illuminating unit and by the window obstruction illumination unit.

Each one of the first light and the second light may have a wavelength between 700 nm-1000 nm. Other wavelengths may be provided. The second light may include one or more second light pulses. The first light may include one or more first light pulses.

Step 1101 may be followed by step 1103 of first detecting, by a detection unit, first reflected light that is reflected from one or more objects within the at least part of the FOV, as a result of the illumination of the at least part of the FOV with the first light.

Step 1102 may be followed by step 1104 of second detecting, by the detection unit second reflected light from the at least part of the WFOV, as a result of the illuminating the at least a part of the WFOV with second light.

Steps 1103 and 1104 may be non-overlapping. The terms “first detecting” and “second detecting” merely provide a distinction between the detecting. They may be overlapping if the detection unit may be capable to perform both detections without severely missing information.

Step 1102 may include illuminating the at least part of the WFOV with the second light at a second timing. Step 1101 may include illuminating the at least part of the FOV with the first light at a first timing to guarantee that the first detecting and the second detecting do not overlap.

Method 1100 may end at steps 1103 and 1104—but for simplicity of explanation FIG. 13 includes additional steps.

Step 1103 and 1104 may be followed by step 1105 of providing to one or more processing units detection signals generated by the detection unit. Step 1105 may include sampling or otherwise reading and/or conveying to the detection signals.

Step 1105 may include at least one of:
a. Step 1106 of first sampling, by a readout unit and at a first sampling rate, first detection signals generated by the detection unit in response to the first reflected light.
b. Step 1107 of second sampling, by a readout unit and at a second sampling rate, second detection signals generated by the detection unit in response to the second reflected light.

The first sampling rate may equal the second sampling rate or may differ from the second sampling rate. For example—the first sampling rate may exceed the second sampling rate

Step 1103 may include or may be preceded by deflecting, the first reflected light by a scanning unit towards the detection unit.

Step 1104 may include or may be preceded by deflecting, the second reflected light by a scanning unit towards the detection unit.

Method 1100 may also include step 1110 of performing determinations.

Step 1110 is illustrated as following steps 1105 and 1106.

Step 1110 may include at least one of:
a. First determining, by at least one first processing unit, FOV object information about the one or more objects.
b. Second determining, by at least one second processing unit, WFOV obstruction information.
c. Generating depth information regarding the objects based on detection signals generated by the detection unit in response to the first reflected light.
d. Generating window obstruction information based on detection signals generated by the detection unit in response to the second reflected light.
   i. The window obstruction information may include at least one of: a blockage indicator, pixel area blocked percent, or a blockage transparency.
   ii. The window obstruction information may include at least one information item out of a location of the obstruction on the window, a size of the obstruction, a shape of the obstruction, a transparency of the obstruction
   iii. The generating of the window obstruction information may also be responsive to at least one of an angle of illumination of the second light, a position information of a deflector that deflected the second reflected light towards the sensing unit, an intensity of the second light, or a second light detection time information.

Step 1110 may be followed by step 1112 of responding to the outcome of step 1110.

Step 112 may include at least one of:
a. Affecting, by the at least one second processing unit, an operating parameter of the FOV illumination unit when an obstruction is detected.
b. Communicating, by the at least one second processing unit, window obstruction information that is indicative of a presence of a blockage.
c. Triggering or controlling a cleaning operation of the window.

The invention is not limited by the specific design of the LIDAR system. In its broader sense, the term ‘LIDAR system’ refers to any LIDAR system that can determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a person touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, ±40°-20°, ±90° or 0°-90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detect light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used in this specification, the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using ϕ, θ angles, in which ϕ and θ are angles defined in perpendicular planes, e.g. with respect to symmetry axes of the LIDAR system and/or its FOV). In one example, the field of view may also be defined within a certain range (e.g. up to 200 m).

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a mirror), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree a, change deflection angle by Aa, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors.

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIGS. 6A, 6B, 7, 8 and 9.

Embodiments of the invention as described herein provide systems and methods for the detection of blockages and obstacles on or near protective windows of LIDAR systems.

It will thus be appreciated that the embodiments described above are cited by way of example and that the present invention is not limited to what has been particularly shown and described hereinabove. Rather, the scope of the present invention includes both combinations and sub-combinations of the various features described hereinabove, as well as variations and modifications thereof.

Those skilled in the art will readily appreciate that various modifications and changes can be applied to the embodiments of the invention as hereinbefore described without departing from its scope defined in and by the appended claims.

1. A LIDAR system for surveying a field of view (FOV) comprising:
an illumination system, a light-sensitive detector, a scanning unit and at least one processing unit,
wherein the illumination system is configured to project a first light with first illumination parameters, deflected by the scanning system through a window toward the field of view of the LIDAR system; and the light-sensitive detector is configured to receive light reflected from objects in the field of view and deflected by the scanning unit; and the at least one processing unit is configured to analyze detected light and determine information about the objects, and
wherein the illumination system is further configured to project a second light with second illumination parameters toward a window vicinity, wherein the first illumination parameters differ from second illumination parameters by at least one illumination parameter; and the light-sensitive detector is configured to receive second light reflections in response to the second light, deflected by the scanning unit; and the at least one processing unit comprises a window module to determine a location of a window blockage based on analysis of the second light reflections and position information of the scanning unit.

2. The LIDAR system of claim 1, wherein the illumination parameters comprise light energy, light intensity, peak power, average power, light wavelength, pulsed light form, pulsed light duration, pulsed light timing.

3. The LIDAR system of claim 1, wherein the at least one illumination parameter comprises light energy, and wherein the light energy of the second light is lower than the light energy of the first light.

4. The LIDAR system of claim 1, wherein each of the first and second light have a wavelength between 700 nm-1000 nm.

5. The LIDAR system of claim 1, wherein the illumination unit is configured to project pulsed light toward the FOV and toward the window vicinity in non-overlapping time intervals such that the light reflected from the field of view in response to projecting the first light and light received in response to projecting the second light toward the light-sensitive detector in non-overlapping time intervals.

6. The LIDAR system of claim 5, further comprising a readout unit configured to read light-sensitive detector signals, and wherein the light reflected from the field of viewFOV is received in a first time interval, and the light received in response to window illumination is received in a second time interval, and; wherein the processing unit controls a readout sampling frequency during a first time interval and a second time interval.

7. The LIDAR system of claim 6, wherein the readout sampling frequency during the second time interval is higher than the frequency in the first time interval.

8. The LIDAR system of claim 1, wherein the illumination system comprises a FOV illumination unit with a first at least one FOV light source configured to project light with the first illumination parameters, and a window illumination unit with a second at least one window light source configured to project light with the second illumination parameters.

9. The LIDAR system of claim 8, wherein the first at least one FOV light source is one of a group consisting of: solid-state laser, laser diode, a high-power laser, vertical-cavity surface-emitting laser (VCSEL), external cavity diode laser (ECDL).

10. The LIDAR system of claim 8, wherein the second at least one window light source is one of a group consisting of: laser source, LED diode, flash light source.

11. The LIDAR system of claim 1, wherein the illumination system comprises a single pulsed light source and a light modulating unit configured to set one or more of the illumination parameters from a group consisting of: light energy, light intensity, peak power, average power, light wavelength, pulsed light form, pulsed light duration, pulsed light timing.

12. The LIDAR system of claim 11, wherein the light modulating unit is configured to set one or more of the first illumination parameters for the projection of the first light towards the FOV and one or more of the second illumination parameters, different from the one or more first illumination parameters, for projection of the second light towards the window vicinity.

13. The LIDAR system of claim 1, wherein the illumination system comprises a single light source with controllable emission energy such that the energy of the second light is lower than the energy of the first light.

14. The LIDAR system of claim Error! Reference source not found., wherein at least one of the first light and the second light is projected as a sequence of light pulses.

15. The LIDAR system of claim 14, wherein both the first light and second light are projected as sequences of light pulses, and wherein a pulse duration of the first light is shorter than the pulse duration of the second light.

16. The LIDAR system of claim 1, wherein the second light reflections are deflected by the scanning unit towards the light-sensitive detector.

17. The LIDAR system of claim 1, wherein the at least one processing unit is further configured to generate point cloud data points comprising distance information relative to objects in the field of view based on signals generated by the light-sensitive detector in response to the first light projected toward the field of view, and blockage information based on signals generated by the at least one light-sensitive detector in response to the second light projected towards the window vicinity.

18. The LIDAR system of claim 17, wherein blockage information includes at least one of: a blockage indicator, percent blockage, and a blockage transparency.

19. (canceled)

20. (canceled)

21. (canceled)

22. The LIDAR system of claim 1, wherein the light-sensitive detector is a SiPM sensor.

23. The LIDAR system of claim 1, wherein the at least one processing unit is configured to perform one or more actions in response to determining the presence of an obstruction on the window, the one or more actions are selected from a group consisting of: determining information about the obstruction, communicating the obstruction information to an external system, and affecting an operating parameter of the FOV illumination unit.

24. The LIDAR system of claim 1, wherein, the processing unit is further configured to determine information about the window blockage including at least one of: a size, a shape, and a transparency of the window blockage, based on at least one of: an angle of illumination, the position information of the scanning unit, intensity of signal, form of signal, and a signal detection time information of the second light.

25. A method for surveying a Field of View (FOV) by a LIDAR system, the method comprising:
projecting first light with first illumination parameters, deflected by a scanning system through a window toward an FOV of the LIDAR system; receiving, by a light-sensitive detector, light reflected from objects in the FOV and deflected by the scanning system; analyzing detected light and determining information about the objects,
projecting second light with second illumination parameters, toward a window vicinity; wherein the first illumination parameters differ from second illumination parameters by at least one illumination parameter;
receiving, by the light-sensitive detector, second light reflections reflected in response to the second light and deflected by the scanning system; and
determine a location of a window blockage based on analysis of the second light reflections and position information of the scanning unit.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A LIDAR system for surveying a Field of View (FOV), comprising:
an illumination system, a light-sensitive detector, a scanning unit and at least one processing unit configured to:
control the illumination unit to project first light with first illumination parameters and second light with second illumination parameters, wherein the first illumination parameters differ from second illumination parameters by at least one illumination parameter;
control the scanning unit to deflect the first light through a window toward the FOV and optionally deflect the second light toward the window, and deflect light reflected from the FOV and the vicinity of the window toward the light-sensitive detector;
analyze light detected by the light-sensitive detector in response to receiving light reflected from at least one object in the field of view and light reflected in response to second light, and
determine a location of an obstruction on the window based on analysis of reflections in response to the second light, and position information of the scanning unit.

39. (canceled)

40. (canceled)

41. The LIDAR system of claim 19, wherein the at least one window light source is positioned behind the window to illuminate a backside of the window at one or more illumination angles.

42. The LIDAR system of claim 8, wherein the window light source is positioned to illuminate the window through an edge of the window.
